(19) United States
(12) Patent Application Publication
(10) Pub. No.: US 2026/0265008 A1
(43) Pub. Date: Sep. 10, 2026

(54) WORKPIECE TAKE-OUT DEVICE

(71) Applicant: G-TEKT CORPORATION, Saitama (JP)

(72) Inventors: Keiji Hisada, Koka-shi, Shiga (JP); Kenta Koshiba, Koka-shi, Shiga (JP)

(21) Appl. No.: 18/838,269

(22) PCT Filed: Mar. 21, 2024
(86) PCT No.: PCT/JP2024/010976

§ 371 Date: May 26, 2026

(30) Foreign Application Priority Data
Mar. 22, 2023 (JP) 2023-045220

(51) Int. Cl. B65G 59/10; B25J 9/16; B25J 15/00; B25J 15/06; B65G 47/91; B65G 59/04

(52) U.S. Cl. CPC B65G 59/10; B25J 9/1697; B25J 15/0019; B25J 15/0625; B25J 15/0683; B65G 47/917; B65G 59/04

(57) ABSTRACT

A workpiece take-out device takes out a plurality of workpieces one by one in order from a top of a workpiece stack. Each of the workpieces includes a portion configured with a U-shaped cross section by at least one first sheet portion of which a sheet surface faces in an up-down direction, and a plurality of second sheet portions which extend from the first sheet portion in the up-down direction and of which sheet surfaces face sideways. The workpiece take-out device includes a robot hand, and a suction unit and a deformation device provided on the robot hand. The suction unit can suction and lift the first sheet portion. The deformation device can elastically deform at least one of the plurality of second sheet portions in a sheet surface direction of the second sheet portion.

### TECHNICAL FIELD

The present invention relates to a workpiece take-out device that takes out a plurality of formed workpieces one by one from the top of a so-called workpiece stack in which the workpieces are stacked (piled) on a cart.

### BACKGROUND ART

Among workpieces, there are relatively large members such as a dashboard lower, a floor panel, and a side sill of a vehicle body. The workpieces are press-formed articles manufactured by press-forming a metal sheet such as a steel sheet, and have a U-shaped cross section. For example, the dashboard lower has a complex three-dimensional shape in which two toe board portions having a U-shaped cross section are provided on the left and right with a tunnel having an inverted U-shaped cross section located at the center and interposed therebetween, and in which a peripheral edge includes a bent joining flange for coupling to an adjacent vehicle body. In addition, a side sill inner or a side sill outer has a hat-shaped cross section formed by adding a flange to one U-shaped cross section, and is long and easily bent.

Since a plurality of the workpieces have a complex three-dimensional shape with a U-shaped cross section or are long or easily bent, when the workpieces are stacked up and down, the workpieces are stacked on a cart with gaps therebetween, and are transferred, for example, from a press process to a processing location for a welding process. At the processing location, the plurality of workpieces stacked on the cart are taken out one by one from the top and are welded.

In recent years, in order to make workpiece take-out device work efficient, the development of a workpiece take-out device using a multi-axis robot or the like that automates the take-out work has progressed. The technique for such a workpiece take-out device is known from, for example, Patent Document 1.

The technique for the workpiece take-out device known from Patent Document 1 is intended for a workpiece that is gently curved, such as a bonnet, and in this technique, an overlapping workpiece on the lower side is separated and made to fall by lifting an upper workpiece and shaking the upper workpiece up and down using a plurality of suction units (suction cups) provided on an arm of a robot, and blowing high-pressure air onto a rear end of the workpiece (refer to paragraph [0023] to paragraph [0025] of Patent Document 1).

### CITATION LIST

### Patent Document

Patent Document 1: Japanese Patent No. 3052003

### SUMMARY OF THE INVENTION

### Problem to be Solved by the Invention

However, some workpieces such as a dashboard lower panel may have a three-dimensional shape that is further curved. This type of workpiece includes at least a first sheet portion of which the sheet surface faces in an up-down direction, and a pair of second sheet portions bent from both end portions of the first sheet portion, and has a U-shaped cross-sectional shape and a steeply curved shape. When the workpieces having a U-shaped cross-sectional shape overlap each other up and down with the first sheet portions facing the top side (upward) after being press-formed, predetermined gaps are provided up and down therebetween, but in many cases, the second sheet portions of the overlapping workpieces are fitted to each other. Particularly, when a plurality of the workpieces are stacked on a cart and transported toward the next welding process, the second sheet portions are likely to be deeply fitted to each other due to vibration of the cart during transportation.

In addition, in the technique described in Patent Document 1, when the suction unit (suction cup) suctions the upper workpiece, the suction unit (suction cup) needs to press the workpiece from above for close contact between the suction cup and the workpiece. For this reason, the upper and lower workpieces are pressed against each other by the suction unit. Thereafter, when the upper workpiece is lifted by the suction unit, the workpiece hangs down due to its own weight with the suction unit as a fulcrum. For this reason, the second sheet portions of the upper workpiece tend to be strongly fitted to the second sheet portions of the lower workpiece. As a result, when the upper workpiece is lifted, the lower workpiece is also lifted.

Challenges remain in reliably taking out the workpieces in such a state of fitting having a U-shaped cross section one by one, as in the technique described in Patent Document 1, simply by lifting the upper workpiece and shaking the upper workpiece up and down using the suction units, and blowing high-pressure air onto a rear end of the workpiece.

An object of the invention is to provide a technique capable of more reliably taking out workpieces one by one even when the workpieces have a U-shaped cross section.

### Means for Solving Problem

As a result of extensive investigation, the present inventors have paid attention to elastic deformation of the U-shaped cross section. Namely, each of the workpieces having a U-shaped cross section includes the first sheet portion of which the sheet surface faces in the up-down direction, and the second sheet portions of which the sheet surfaces face sideways. It has been discovered that since the first sheet portion of each of the workpieces overlapping each other up and down is suctioned and lifted by the suction units, the elastic deformation of one second sheet portion is linked to the elastic deformation of the other second sheet portion and the state of up/down fitting is released. It has been found that the workpieces can be more reliably taken out one by one by adding a lifting operation to the elastic deformation. The invention has been completed based on this finding. Incidentally, “the sheet surface facing in the up-down direction” or “the sheet surface facing sideways” also includes a case where the sheet surface faces diagonally up and down or sideways.

According to the present disclosure, there is provided a workpiece take-out device that takes out a plurality of workpieces one by one in order from a top of a workpiece stack, the workpiece stack being composed of the plurality of workpieces stacked in an up-down direction with gaps between the workpieces, and each of the plurality of workpieces being composed of a formed sheet material, and including a portion configured with a U-shaped cross section by at least one first sheet portion of which a sheet surface faces in the up-down direction, and a plurality of second sheet portions which extend from the first sheet portion in the up-down direction and of which sheet surfaces face sideways, the device including: a robot hand provided in a robot; at least one suction unit provided on the robot hand, and capable of suctioning and lifting the first sheet portion of the workpiece located at an upper end of the workpiece stack; and at least one deformation device provided on the robot hand, and capable of elastically deforming at least one of the plurality of second sheet portions of the workpiece in a sheet surface direction of the second sheet portion, the workpiece being located at the upper end, with a contact portion with the overlapping workpiece immediately below as a fulcrum, and linking the elastic deformation to the confronting second sheet portion via the suction unit.

### Effect of the Invention

The present disclosure can provide a technique capable of more reliably taking out workpieces one by one even when the workpieces have a steeply curved shape and include portions configured with a U-shaped cross section. Namely, attention is paid to elastic deformation of the U-shaped cross section. Namely, each of the workpieces having a U-shaped cross section includes the first sheet portion of which the sheet surface faces in the up-down direction, and the second sheet portions of which the sheet surfaces face sideways. It has been discovered that in the workpieces overlapping each other up and down with gaps therebetween, the elastic deformation of one second sheet portion is linked to the elastic deformation of the confronting other second sheet portion via the suction unit with the contact portion with the lower workpiece as a fulcrum, and releases the state of up/down fitting of the other second sheet portion. It has been found that the workpieces can be more reliably taken out one by one by adding a lifting operation to the elastic deformation. The invention has been completed based on this finding.

### BRIEF DESCRIPTION OF DRAWINGS

FIG. 1A is a perspective view of a workpiece that is taken out by a workpiece take-out device according to a first embodiment, FIG. 1B is an end view of the workpiece when viewed in the direction of arrow 1B in FIG. 1A, and FIG. 1C is a schematic view of a workpiece stack composed of a plurality of the workpieces illustrated in FIG. 1B, and the workpiece take-out device;

FIG. 2 is a schematic view of the workpiece stack and the workpiece take-out device according to the first embodiment;

FIG. 3 is a schematic view of a suction unit illustrated in FIG. 2;

FIG. 4 is a schematic view of a deformation device illustrated in FIG. 2;

FIG. 5 is a first half of a control flowchart of a control unit illustrated in FIG. 2;

FIG. 6 is a second half of the control flowchart of the control unit illustrated in FIG. 2;

FIG. 7A is an action view illustrating the operation of pressing the suction unit against the upper workpiece illustrated in FIG. 1C, FIG. 7B is an action view illustrating the operation of pressing the deformation device against the upper workpiece illustrated in FIG. 7A, and FIG. 7C is an action view illustrating a deformation state of the upper workpiece illustrated in FIG. 7B;

FIG. 8A is an action view illustrating a state where the upper workpiece illustrated in FIG. 7C is lifted and separated away from the deformation device, FIG. 8B is an action view illustrating a state where the upper workpiece illustrated in FIG. 8A is returned to the original horizontal state, and FIG. 8C is an action view illustrating a state where the upper workpiece illustrated in FIG. 8B is transferred to a position for a next process;

FIG. 9 is a schematic view of a deformation device of a workpiece take-out device according to a second embodiment;

FIG. 10A is a perspective view of a workpiece that is taken out by a workpiece take-out device according to a third embodiment, FIG. 10B is an end view of the workpiece when viewed in the direction of arrow 10B in FIG. 10A, and FIG. 10C is a schematic view of a workpiece stack composed of a plurality of the workpieces illustrated in FIG. 10B;

FIG. 11 is a perspective view of a workpiece that is taken out by a workpiece take-out device according to a fourth embodiment;

FIG. 12A is a rear view of the workpiece when viewed in the direction of arrow 12A in FIG. 11, and FIG. 12B is a cross-sectional view of the workpiece taken along line 12B-12B in FIG. 12A. FIG. 12C is a cross-sectional view of the workpiece taken along line 12C-12C in FIG. 12A. FIG. 12D is a cross-sectional view of the workpiece taken along line 12D-12D in FIG. 12A;

FIG. 13 is a perspective view describing a positional relationship of suction units and deformation devices with respect to the workpiece illustrated in FIG. 12A;

FIG. 14 is a view further conceptually illustrating the workpiece illustrated in FIG. 13;

FIG. 15 is a schematic view of a workpiece stack composed of a plurality of the workpieces illustrated in FIG. 12B, and the workpiece take-out device; and

FIG. 16A is an action view illustrating the operation of pressing the suction units against the upper workpiece illustrated in FIG. 15, FIG. 16B is an action view illustrating a deformation state where the upper workpiece illustrated in FIG. 16A is pressed against the deformation devices, and FIG. 16C is an action view illustrating a state where the upper workpiece illustrated in FIG. 16B is lifted and separated away from the deformation devices.

### MODE(S) FOR CARRYING OUT THE INVENTION

Embodiments of the invention will be described below with reference to the accompanying drawings. Incidentally, the forms illustrated in the accompanying drawings are examples of the invention, and the invention is not limited to the forms.

### First Embodiment

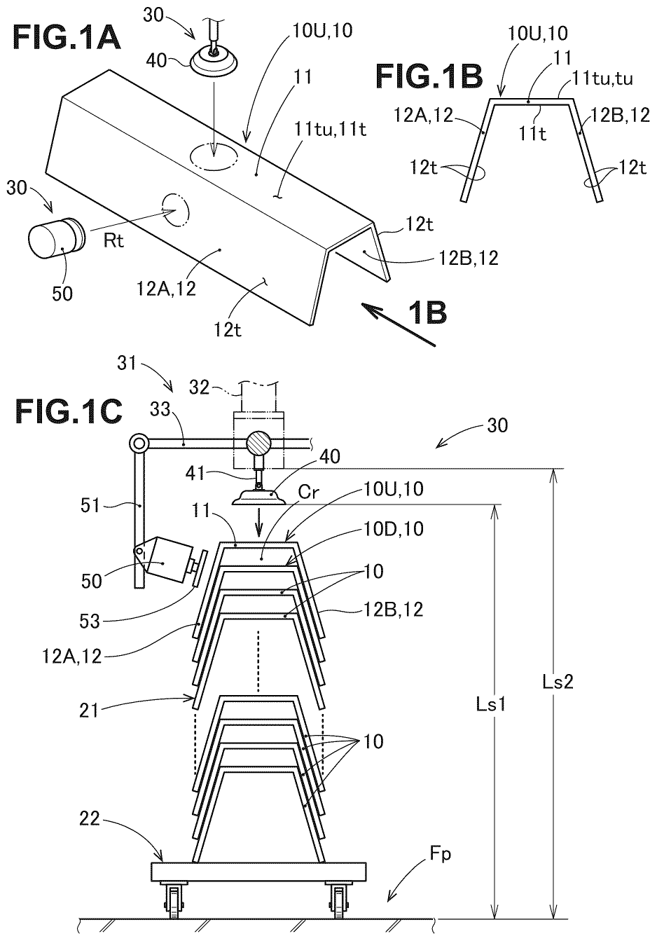

A workpiece take-out device 30 according to a first embodiment and a workpiece 10 that is taken out by the workpiece take-out device 30 will be described with reference to FIG. 1 to FIG. 8.

FIG. 1A to FIG. 1C illustrate a plurality of the workpieces 10 that are taken out by the workpiece take-out device 30. The workpieces 10 are composed of formed sheet materials. For example, the workpieces 10 are press-formed articles made of a metal sheet material such as a metal sheet or a light metal sheet, or a resin sheet material, and can be used as, for example, a vehicle body panel constituting a part of a vehicle body. Since the workpieces 10 are press-formed articles made of a metal sheet material or a resin sheet material, the workpieces 10 can be more elastically deformed than forged articles or cast articles. An example of the press-formed article made of a resin sheet material is a hot press-formed article. In addition, the workpiece 10 includes a resin panel that is injection-formed.

Each of the workpieces 10 includes a portion that is configured with a U-shaped cross section by at least one (one in the first embodiment) first sheet portion 11 of which sheet surfaces 11t and 11t face in an up-down direction and a plurality (two in the first embodiment) of second sheet portions 12 which extend in the up-down direction from the first sheet portion 11 and of which sheet surfaces 12t and 12t face sideways. The workpiece 10 is configured as, for example, a long member such as a side sill inner or a side sill outer (refer to FIG. 1A).

As illustrated in FIG. 1C, a workpiece stack 21 is formed by stacking the plurality of workpieces 10 in the up-down direction with gaps Cr therebetween. For example, the plurality of workpieces 10 are stacked on a cart 22 (the illustration of a frame frame portion of the cart 22 is omitted) with the lower side open, and are moved to a take-out location Fp (pick-up position Fp). In such a manner, each of the workpieces 10 includes at least one protruding portion that protrudes upward when each of the workpieces 10 is stacked as the workpiece stack 21. The protruding portion is a portion that is configured with a U-shaped cross section by the first sheet portion 11 and a pair of the second sheet portions 12.

Here, of the sheet surfaces 11t and 11t on both sides of the first sheet portion 11, particularly the sheet surface 11t on the upper side is referred to as an “upper surface 11tu (sheet surface 11tu on the upper side)” The sheet surface 11tu on the upper side of the first sheet portion 11 forms the upper surface 11tu on a protruding side of the protruding portion, and is in a horizontal state (including a substantially horizontal state).

In addition, each of the workpieces 10 constituting the workpiece stack 21 is defined as follows. The uppermost workpiece 10 located at an upper end of the workpiece stack 21 is particularly referred to as an “upper workpiece 10U (highest-positioned workpiece 10U)”, and the overlapping workpiece 10 immediately below the upper workpiece 10U is referred to as a “lower workpiece 10D (lower-positioned workpiece 10D)”.

The gap Cr in the up-down direction for stacking the same U-shaped cross sections is provided between the first sheet portion 11 of the upper workpiece 10U and the first sheet portion 11 of the lower workpiece 10D.

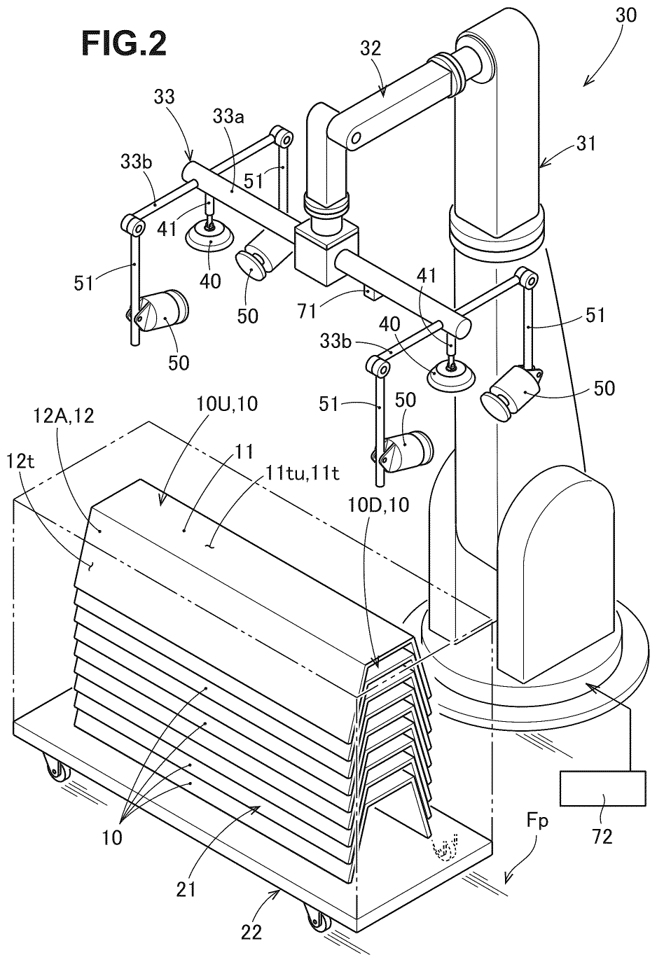

As illustrated in FIG. 2, the workpiece take-out device 30 is configured to be able to take out the plurality of workpieces 10 one by one in order from the top of the workpiece stack 21 on the cart 22 located at the workpiece take-out location Fp (pick-up position Fp). The workpiece take-out device 30 includes an industrial robot 31 (hereinafter, abbreviated as the “robot 31”) installed at the workpiece take-out location Fp; a robot hand 33 provided in the robot 31; and at least one suction unit 40 and at least one deformation device 50 provided on the robot hand 33.

The robot 31 is, for example, a multi-axis or vertical articulated robot, and includes a robot arm 32. The robot hand 33 is provided at a tip of the robot arm 32. The configuration, size, and shape of the robot hand 33 are random, and may be appropriately set such that the plurality of workpieces 10 are taken out one by one in order from the top of the workpiece stack 21 by the suction unit 40 and the deformation device 50.

For example, the robot hand 33 includes a main hand 33a having a bar shape which is connected to the tip of the robot arm 32, and a pair of sub-hands 33b and 33b having a bar shape which is connected to both ends of the main hand 33a. The main hand 33a can be configured to be advanceable and retreatable in its own bar longitudinal direction with respect to the tip of the robot arm 32. In addition, the sub-hands 33b and 33b can be configured to be advanceable and retreatable in its own bar longitudinal direction and to be swingable with respect to the main hand 33a.

Further, the workpiece take-out device 30 includes a three-dimensional vision sensor 71 (3D vision sensor 71) and a control unit 72.

The 3D vision sensor 71 is a type of measuring instrument that three-dimensionally recognizes an object, and generates three-dimensional measurement data (three-dimensional image data). The 3D vision sensor 71 generates three-dimensional measurement data of the upper workpiece 10U of the workpiece stack 21 that is transferred to the take-out location Fp by the cart 22, and sends the three-dimensional measurement data to the control unit 72. The 3D vision sensor 71 is provided on the robot hand 33 to be able to detect (recognize) a position and an angle of the upper workpiece 10U located at the upper end of the workpiece stack 21.

The control unit 72 controls the robot 31, the robot hand 33, the suction unit 40, and the deformation device 50. Details of control contents will be described later.

Further, the control unit 72 is configured to correct the posture of the robot hand 33 based on the position and the angle of the workpiece 10 located at the upper end, which are detected (recognized) by the 3D vision sensor 71. Namely, when there is a change in relationship between a sensor coordinate system detected (recognized) by the 3D vision sensor 71 and an actual coordinate system of the workpieces 10, the position of the robot hand 33 including the 3D vision sensor 71 is corrected.

The cart 22 is not limited to being accurately set at a predetermined position of the take-out location Fp. In addition, the position and the angle of each of the workpieces 10 of the workpiece stack 21 loaded on the cart 22 are limited to being constant. Meanwhile, the control unit 72 can individually and accurately position the positions of the suction unit 40 and the deformation device 50 with respect to each of the workpieces 10 by correcting the position of the robot hand 33 based on the relationship between the sensor coordinate system and the actual coordinate system of the workpieces 10.

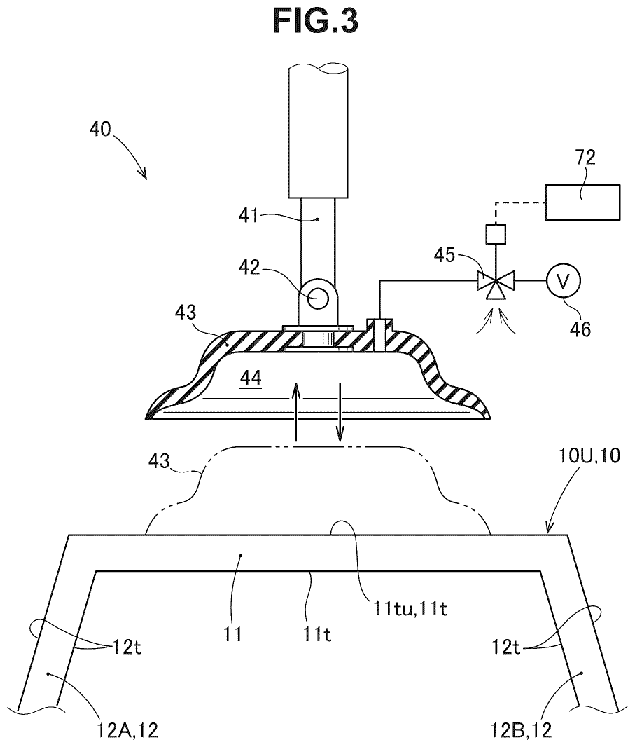

As illustrated in FIG. 3, the suction unit 40 can suction and lift the upper surface 11tu of the first sheet portion 11 of the upper workpiece 10U of the workpiece stack 21 (refer to FIG. 1C), and is configured as, for example, a vacuum suction type. The suction unit 40 includes a rod 41 extending downward from the robot hand 33 (refer to FIG. 1C), and a suction cup 43 attached to a tip portion of the rod 41 via a pivot 42. A recessed space portion 44 of the suction cup 43 is connected to a suction port of a vacuum pump 46 via a switching valve 45 (first switching valve 45).

The first switching valve 45 is composed of, for example, an electromagnetic three-way valve of which the switching is controlled by the control unit 72. The first switching valve 45 maintains the space portion 44 in a vacuum or negative pressure state by normally communicating between the space portion 44 of the suction cup 43 and the suction port of the vacuum pump 46, and receives a signal from the control unit 72 to return pressure in the space portion 44 to atmospheric pressure.

Incidentally, the suction unit 40 is not limited to being configured as a vacuum suction type, and may be configured as, for example, a magnet type that is operated by exciting and de-exciting an electromagnet. In this case, the operation of the electromagnet is controlled by the control unit 72. In addition, when the upper workpiece 10U is viewed from above, it is preferable that a position on the upper surface 11tu of the first sheet portion 11, which is lifted by the suction unit 40, is the center of gravity of the upper workpiece 10U. The reason is that the upper workpiece 10U can be stably lifted without being inclined.

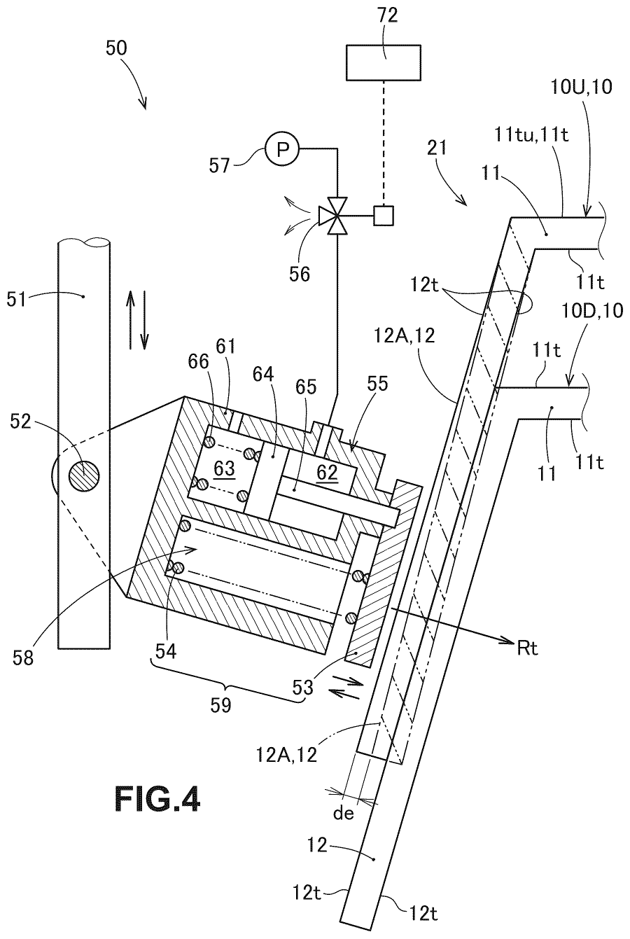

As illustrated in FIG. 4, the deformation device 50 can elastically deform at least one of the plurality of second sheet portions 12 in a sheet surface direction Rt (pushing direction Rt) of the second sheet portion 12.

Here, referring also to FIG. 1, of the plurality of second sheet portions 12 of the upper workpiece 10U, the second sheet portion 12 that is elastically deformed in the sheet surface direction Rt of the second sheet portion 12 by the deformation device 50 is referred to as a “specific second sheet portion 12A”, and the other second sheet portion 12 confronting (facing) the specific second sheet portion 12A is referred to as a “remaining second sheet portion 12B”.

As illustrated in FIG. 4, the deformation device 50 is attached via a pivot 52 to a tip portion of a rod 51 extending downward from the robot hand 33. The deformation device 50 includes a pushing portion 53 capable of pushing the specific second sheet portion 12A in the sheet surface direction Rt; a pressing spring 54 that biases the pushing portion 53 in the sheet surface direction Rt of the specific second sheet portion 12A; and an actuator 55 that separates the pushing portion 53 away from the specific second sheet portion 12A against the biasing force of the pressing spring 54. The pressing spring 54 is composed of a compression spring. Incidentally, the compression spring 54 can elastically deform a larger workpiece by coming out of a cylinder 61 to be described later to become larger.

A deformation amount de by which the deformation device 50 elastically deforms the specific second sheet portion 12A using the pressing spring 54 is set to a size that can separate the state of fitting of the other second sheet portion 12 to the lower-positioned workpiece 10D.

It is preferable that the sheet surface direction Rt in which the specific second sheet portion 12A is pushed by the deformation device 50 is a direction perpendicular to the sheet surface 12t of the specific second sheet portion 12A. This direction allows the effective elastic deformation of the specific second sheet portion 12A.

The actuator 55 includes the cylinder 61 connected to the robot hand 33; a piston 64 that partitions the inside of the cylinder 61 into a pressurizing chamber 62 and a spring chamber 63; a piston rod 65 connecting the piston 64 and the pushing portion 53; and a return spring 66 stored in the spring chamber 63. The return spring 66 is composed of a compression spring.

The pressurizing chamber 62 is connected to a discharge port of a compressor 57 via a switching valve 56 (second switching valve 56). The second switching valve 56 is composed of, for example, an electromagnetic three-way valve of which the switching is controlled by the control unit 72. The second switching valve 56 allows pressurized air from the compressor 57 to pressurize the pressurizing chamber 62 by normally communicating between the discharge port of the compressor 57 and the pressurizing chamber 62. The piston 64 retreats against the biasing forces of the pressing spring 54 and the return spring 66, and separates the pushing portion 53 away from the specific second sheet portion 12A via the piston rod 65.

When the second switching valve 56 receives a signal from the control unit 72, and switches the pressurizing chamber 62 to a state where the pressurizing chamber 62 is opened to the atmosphere, the pressing spring 54 can press the pushing portion 53 against the specific second sheet portion 12A by means of the biasing force.

As the second switching valve 56 repeats a switching operation in response to a control signal from the control unit 72, the pushing portion 53 can repeat a pushing operation and a separation operation with respect to the sheet surface 12t of the specific second sheet portion 12A. Namely, the deformation device 50 also includes the configuration (function) of a vibrator 58 that applies vibration to the second sheet portion 12 in the sheet surface direction Rt. The vibrator 58 is composed of the pushing portion 53, the pressing spring 54, the pressurizing chamber 62, and the piston 64. Further, a spring mechanism 59 is composed of the pushing portion 53 and the pressing spring 54.

The pressing spring 54 can be elastically deformed (contracting action) at the same time that the pushing portion 53 comes into contact with the sheet surface 12t of the specific second sheet portion 12A, and the biasing force of the pressing spring 54 has both the function of strengthening a collision force (hitting force) with which the pushing portion 53 collides with the sheet surface 12t of the specific second sheet portion 12A, and the function of amplifying a force with which the pushing portion 53 pushes the sheet surface 12t of the specific second sheet portion 12A. For this reason, the lower workpiece fitted to the upper workpiece 10U can be effectively removed by the deformation device 50.

In such a manner, the pressing spring 54 applies a biasing force to the sheet surface 12t of the specific second sheet portion 12A, the biasing force being capable of bringing the entirety of the upper workpiece 10U into an elastic deformation state, together with the specific second sheet portion 12A. The application of the biasing force of the pressing spring 54 is released by the actuator 55.

The period of a pushing operation and a separation operation with respect to the sheet surface 12t of the specific second sheet portion 12A by the deformation device 50, the duration of the pushing operation or the duration of the separation operation, and the intensity of vibration (the pressing intensity of the pushing portion 53 against the sheet surface 12t of the specific second sheet portion 12A) are set such that when the lower workpiece 10D is fitted to the upper workpiece 10U, the lower workpiece 10D is easily removed by elastically deforming the upper workpiece 10U. For example, the control unit 72 can control the deformation device 50 to press the sheet surface 12t of the specific second sheet portion 12A only once or only several times or to continuously apply vibration thereto using the pushing portion 53.

Incidentally, the actuator 55 may be configured to separate the pushing portion 53 away from the specific second sheet portion 12A against the biasing force of the pressing spring 54, and can be configured as, for example, a solenoid.

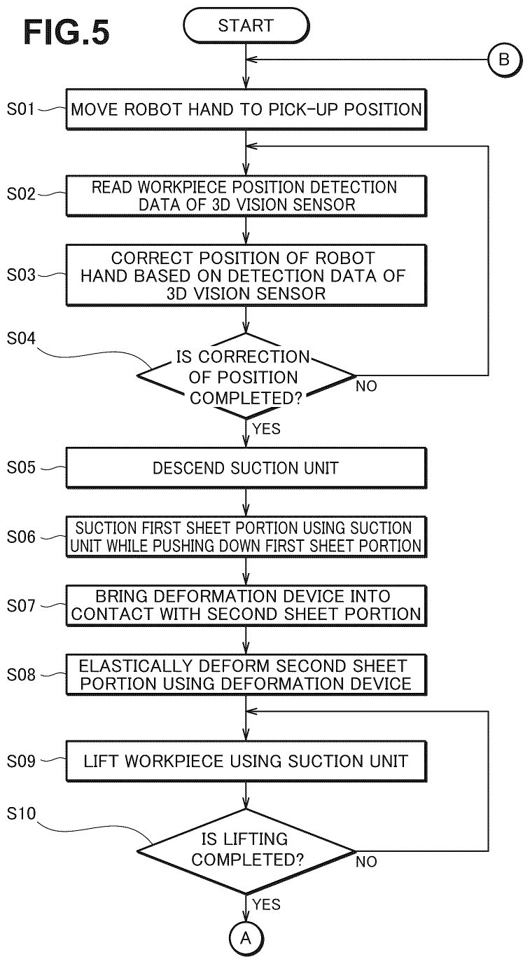

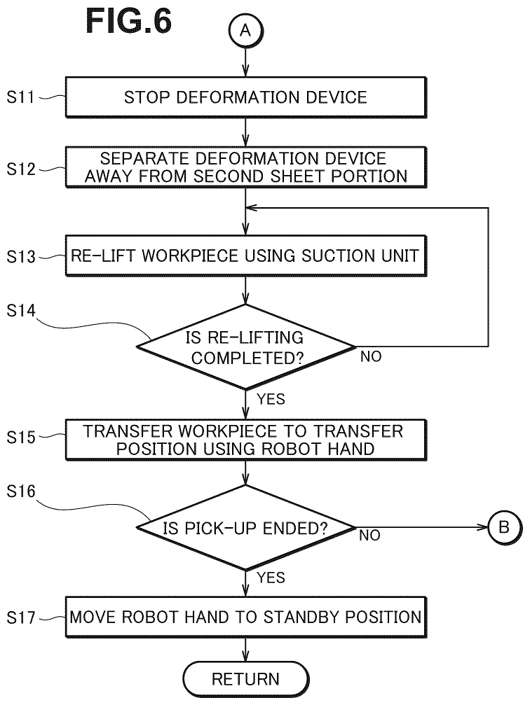

Next, control by the control unit 72 will be described based on FIG. 5 and FIG. 6 while referring to FIG. 1 to FIG. 4. The control unit 72 is composed of, for example, a microcomputer. One example of specific control by the control unit 72 composed of a microcomputer will be described as follows.

FIG. 5 and FIG. 6 are control flowcharts of the control unit 72, and illustrate a subroutine for executing the process of controlling the operation of the robot 31, the robot hand 33, the suction unit 40, and the deformation device 50 in a series of controls by the control unit 72. The subroutine is executed, for example, by interrupt processing based on a predetermined condition, or by time-sharing processing.

When the control unit 72 starts control, first, in step S01, the control unit 72 controls the driving of the robot 31 and the robot hand 33 such that the robot hand 33 is moved from a standby position (not illustrated) to above the workpiece stack 21 loaded on the cart 22, namely, to the pick-up position Fp.

In next step S02, detection data of the position and the angle of the upper workpiece 10U, namely, three-dimensional measurement data detected (recognized) by the 3D vision sensor 71 provided on the robot hand 33 is read.

In next step S03, the position of the robot hand 33 is corrected based on the detection data of the detected position and angle of the upper workpiece 10U.

In next step S04, it is determined whether the position correction of the robot hand 33 is completed, and step S02 and step S03 are repeated until it is determined that the position correction is completed. The position and the angle of each of the workpieces 10 of the workpiece stack 21 loaded on the cart 22 are not constant. In order to reliably take out only the upper workpiece 10U from the workpiece stack 21, it is necessary to determine the accurate position of the robot hand 33, on which the suction unit 40 and the deformation device 50 are provided, with respect to the upper workpiece 10U. The accurate position of the robot hand 33 can be set by performing step S02 and step S03. When it is determined in step S04 that the position correction is completed, the process proceeds to next step S05.

In step S05, the driving of the robot arm 32 and the robot hand 33 is controlled so as to be lowered, so that the suction unit 40 descends.

In next step S06, while the upper surface 11tu of the first sheet portion 11 of the upper workpiece 10U is pushed down by the suction unit 40, the suction unit 40 is made to suction the upper surface 11tu. Specifically, the inside of the suction cup 43 is in a vacuum state or a decompression state. The driving of the robot arm and the robot hand 33 is controlled so as to be lowered, so that the suction cup 43 is made to suction the first sheet portion 11 of the upper workpiece 10U. Incidentally, when step S06 is executed, the pushing portion 53 of the deformation device 50 pushes and elastically deforms the specific second sheet portion 12A of the second sheet portions 12 of the upper workpiece 10U.

Namely, in next step S07, the deformation device 50 is brought into contact with the specific second sheet portion 12A of the upper workpiece 10U. Subsequently, in next step S08, the specific second sheet portion 12A is continuously elastically deformed or intermittently elastically deformed by the deformation device 50. More specifically, the control unit 72 controls the switching of the second switching valve 56 (refer to FIG. 4) to cause the pressing spring 54 to press the pushing portion 53 against the specific second sheet portion 12A by means of the biasing force. As a result, the specific second sheet portion 12A is elastically deformed toward a remaining second sheet portion 12B side. At this time, a pressing force acting on the specific second sheet portion 12A is transmitted to the remaining second sheet portion 12B via the suctioned first sheet portion 11, and the remaining second sheet portion 12B is also elastically deformed in the same direction as the pushing direction.

In next step S09 after a certain reference time (pressing reference time) set in advance has elapsed since step S08 is executed, by controlling the driving of the robot arm 32 and the robot hand 33, the suction unit 40 is made to lift the upper workpiece 10U by a predetermined distance, namely, by a distance (first reference height Ls1 illustrated in FIG. 1C) that allows the upper workpiece 10U to return to a position overlapping the lower workpiece 10D even when the state of fitting is released and the upper workpiece 10U falls. In this case, it is preferable that the upper workpiece 10U is rapidly lifted on the assumption that the upper workpiece 10U is fitted to lower workpiece 10D. By rapidly lifting the upper workpiece 10U, the lower workpiece 10D is made likely to fall due to its own inertia. At this stage, the elastic deformation operation of the specific second sheet portion 12A by the deformation device 50 continues.

In next step S10, it is determined whether the lifting operation of the upper workpiece 10U by the suction unit 40 is completed. For example, when the height of the upper workpiece 10U that is lifted reaches the first reference height Ls1 (refer to FIG. 1C) set in advance, it is determined that the lifting operation is completed. Here, the first reference height Ls1 is set to, for example, a certain height from a floor surface at the pick-up position Fp. Namely, it is determined whether the lifting of the upper workpiece 10U to the separation position Ls1 (first reference height Ls1) with respect to the lower workpiece 10D is completed. An actual lift height of the upper workpiece 10U is detected by a height detection unit (not illustrated). Step S09 continues until it is determined in step S10 that the lifting operation is completed. When it is determined in step S10 that the lifting operation is completed, the process proceeds to next step S11.

In step S11, the elastic deformation operation of the specific second sheet portion 12A by the deformation device 50 is stopped. Subsequently, in next step S12, the deformation device 50 is separated away from the specific second sheet portion 12A. More specifically, the control unit 72 controls the switching of the second switching valve 56 (refer to FIG. 4). The piston 64 retracts to separate the pushing portion 53 away from the specific second sheet portion 12A. Due to the separation, the elastic deformation is released, the upper workpiece 10U is swung back with the suction unit 40 as a fulcrum, the state of fitting is released, and the lower workpiece 10D may fall downward.

In next step S13, by controlling the driving of the robot arm 32 and the robot hand 33, the suction unit 40 is made to further lift (re-lift) the upper workpiece 10U. The state of fitting between the upper workpiece 10U and the lower workpiece 10D is released due to inertia caused by the re-lifting, and the lower workpiece 10D may fall downward.

In next step S14, it is determined whether the lifting operation of the upper workpiece 10U by the suction unit 40 is completed. For example, when the height of the upper workpiece 10U that is lifted reaches a second reference height Ls2 (refer to FIG. 1C) set in advance, it is determined that the lifting operation is completed. Here, the second reference height Ls2 is set to, for example, a certain height from the floor surface at the pick-up position Fp, and is higher than the first reference height Ls1. An actual lift height of the upper workpiece 10U is detected by a height detection unit (not illustrated). Step S13 continues until it is determined in step S14 that the re-lifting operation is completed. When it is determined in step S14 that the re-lifting operation is completed, the process proceeds to next step S15.

In step S15, the upper workpiece 10U lifted by the suction unit 40 is transferred to a position (transfer position) for a welding process, which is the next process, by controlling the driving of the robot arm 32 and the robot hand 33. At the transfer position, the suction unit 40 separates from the upper workpiece 10U. Specifically, the control unit 72 controls the switching of the first switching valve 45 to return the space portion 44 of the suction cup 43 to atmospheric pressure. As a result, the upper workpiece 10U is separated from the suction unit 40.

In next step S16, it is determined whether the next workpiece 10 is taken out from the workpiece stack 21. For example, when a detection unit (not illustrated) detects that the workpieces 10 remain on the cart 22, or a worker does not operate an end switch (not illustrated), in order to take out the next workpiece 10, the process returns to step S01, and the workpiece take-out operation continues. In step S16, when it is determined that the next workpiece 10 is not to be taken out, namely, the pick-up is completed, the process proceeds to step S17. In step S17, the robot hand 33 is moved to the standby position (not illustrated), and then the subroutine is ended.

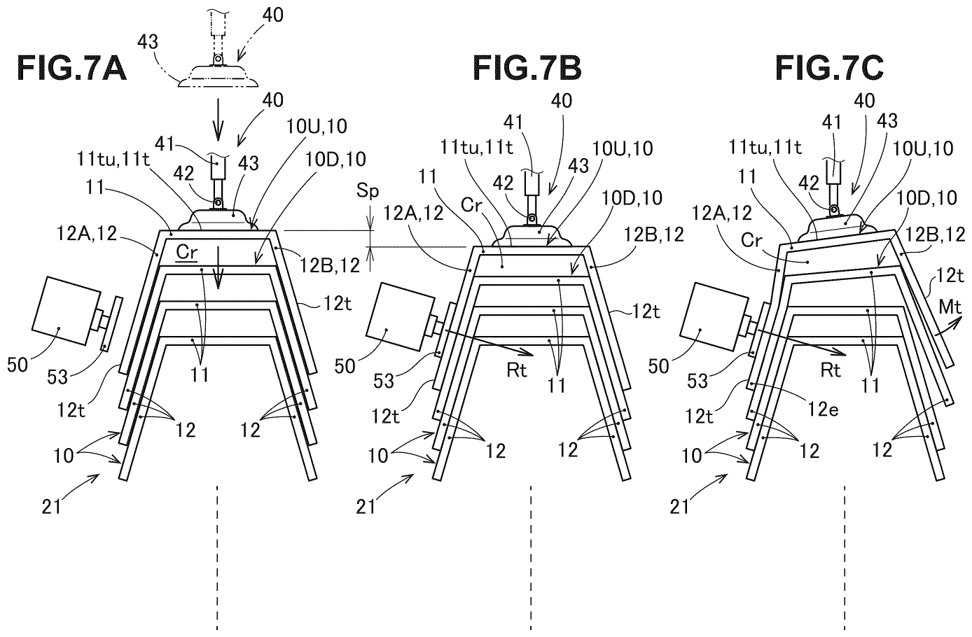

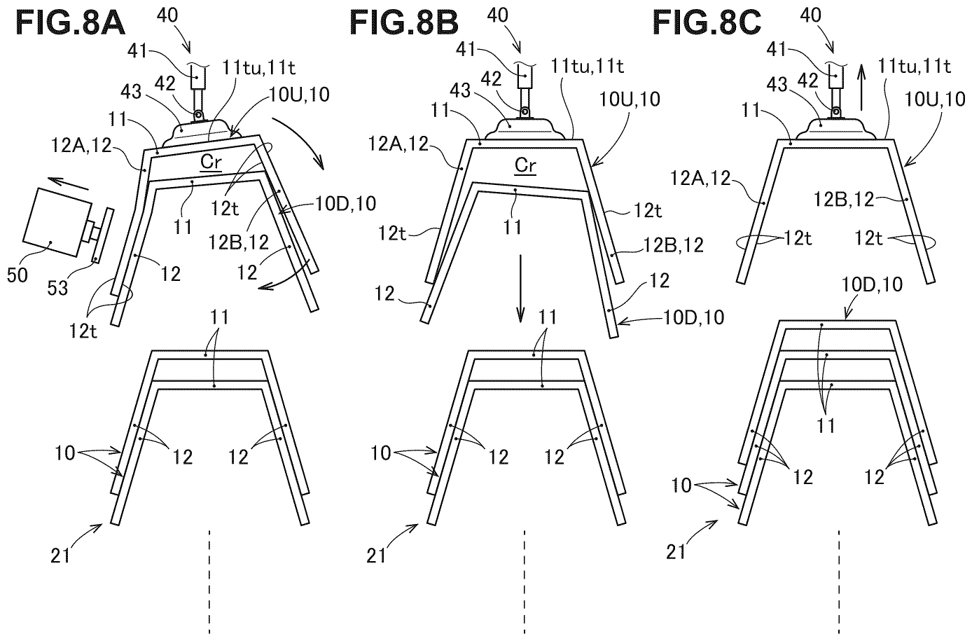

Next, the operation (workpiece take-out method) of the workpiece take-out device 30 will be described with reference to FIG. 7 and FIG. 8.

First, as illustrated in FIG. 7A, the suction unit 40 descends and suctions the upper surface 11tu of the first sheet portion 11 of the upper workpiece 10U while pushing down the upper surface 11tu of the first sheet portion 11 (refer to step S05 and step S06 in FIG. 5). At this time, the upper workpiece 10U is lowered by a certain push-down amount Sp set in advance. The push-down amount Sp is set to a down amount that can bring the suction cup 43 into close contact with the upper workpiece 10U.

At the same time or next, as illustrated in FIG. 7B, the specific second sheet portion 12A of the upper workpiece 10U is elastically deformed by the deformation device 50 (refer to step S07 and step S08 in FIG. 5). Namely, the deformation device 50 strongly presses or vibrates the pushing portion 53 against the specific second sheet portion 12A by means of only the strong biasing force of the pressing spring 54 (refer to FIG. 4). The pressing spring 54 can apply the biasing force to the sheet surface 12t of the specific second sheet portion 12A via the pushing portion 53, the biasing force being capable of bringing the entirety of the upper workpiece 10U into an elastic deformation state, together with the specific second sheet portion 12A.

As a result, as illustrated in FIG. 7C, a lower end portion 12e (contact portion 12e) of the specific second sheet portion 12A comes into contact with the second sheet portion 12 of the lower workpiece 10D to become a fulcrum for elastic deformation, and the elastic deformation is linked via the suction unit 40, and the specific second sheet portion 12A elastically deforms toward the confronting remaining second sheet portion 12B side (sheet surface direction Rt). Namely, due to the pressing force (the strong biasing force of the pressing spring 54 illustrated in FIG. 4) acting from the deformation device 50 on the specific second sheet portion 12A, a force moment Mt acts on the upper workpiece 10U via the suction unit 40 (strictly speaking, the pivot 42) with the lower end portion 12e (contact portion 12e) of the specific second sheet portion 12A as a fulcrum (namely, the elastic deformation is linked). For this reason, the entirety of the upper workpiece 10U elastically deforms around the suction unit 40 in the sheet surface direction Rt (counterclockwise direction in FIG. 7C) together with the specific second sheet portion 12A.

In the process in which the upper workpiece 10U elastically deforms in the sheet surface direction Rt, the confronting remaining second sheet portion 12B of the upper workpiece 10U elastically deforms in a direction away from the other second sheet portion 12 of the lower workpiece 12D (fitting release direction) with the contact portion 12e with one second sheet portion 12 of the lower workpiece 10D as a fulcrum. As a result, the upper workpiece 10U is removed from the lower workpiece 10D. In such a manner, even when the upper workpiece 10U is fitted to the lower workpiece 10D, by elastically deforming the specific second sheet portion 12A in the sheet surface direction Rt using the deformation device 50, the state of fitting of the specific second sheet portion 12A to the second sheet portion 12 of the lower workpiece 10D is easily removed.

Next, as also illustrated in FIG. 7C, the upper workpiece 10U is rapidly lifted by the suction unit 40 (refer to step S09 and step S10 in FIG. 5). Namely, the upper workpiece 10U is rapidly raised. As a result, the lower workpiece 10D fitted to the upper workpiece 10U is easily removed and falls due to inertia.

Next, when the state of fitting to the lower workpiece 10D is not released, as illustrated in FIG. 8A, the deformation device 50 is stopped and separated away from the specific second sheet portion 12A of the upper workpiece 10U that is lifted (refer to step S11 and step S12 in FIG. 6). As a result, the upper workpiece 10U that is lifted swings back toward a specific second sheet portion 12A side as a whole, and returns to the original horizontal state as illustrated in FIG. 8B. The state of fitting of the lower workpiece 10D to the upper workpiece 10U is easily removed due to the swing-back.

Finally, the lower workpiece 10D is removed and falls from the upper workpiece 10U. Incidentally, if the state of fitting remains, the deformation device 50 can also be vibrated.

Next, as illustrated in FIG. 8C, only the upper workpiece 10U lifted by the suction unit 40 is transferred to the transfer position by the robot hand 33 (refer to step S13 to step S15 in FIG. 6).

In such a manner, the workpiece take-out device 30 can reliably take out only the upper workpieces 10U one by one from the top of the workpiece stack 21, and move the upper workpieces 10U to the pick-up position Fp.

### Second Embodiment

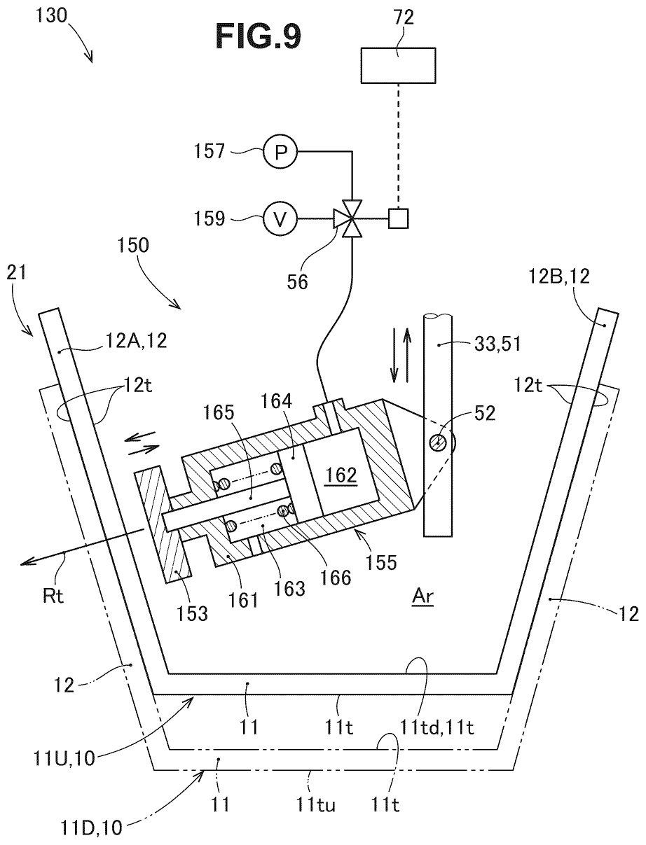

A workpiece take-out device 130 of a second embodiment will be described with reference to FIG. 9. FIG. 9 corresponds to FIG. 4.

The workpiece take-out device 130 of the second embodiment is characterized in that the deformation device 50 of the first embodiment illustrated in FIG. 1 to FIG. 8 is changed to a deformation device 150 illustrated in FIG. 9. The other basic configurations are common to the workpiece take-out device 30 according to the first embodiment. The same reference signs are used for portions that are common to the workpiece take-out device 30 according to the first embodiment, and detailed description thereof will be omitted.

The deformation device 150 of the second embodiment (refer to FIG. 9) is characterized by being small since the deformation device 150 performs pulling and pushing using only an actuator 155 without including the pressing spring 54 (refer to FIG. 4) that is large as in the deformation device 50 of the first embodiment (refer to FIG. 4). For this reason, the deformation device 150 is particularly preferable for use at a narrow location where the deformation device 50 cannot be put, or when a plurality of the workpieces 10 are oriented upside down from the orientation of the first embodiment. Namely, the present embodiment is suitable for positioning the deformation device 150, which is small, in a narrow space Ar between the second sheet portions 12 and 12 of the upper workpiece 10U when the distance between the second sheet portions 12 and 12 of which the U-shaped cross sections are adjacent to each other side by side to the left and right is narrow, or when dashboard lower tunnel portions or as illustrated in FIG. 9, a plurality of the workpieces 10 are stacked as the workpiece stack 21 on the cart 22 (refer to FIG. 1C) with the upper side open. In this case, the suction unit 40 illustrated in FIG. 3 can suction and lift a bottom surface 11td (11t) of the first sheet portion 11 of the upper workpiece 10U.

As described above, in the second embodiment, each of the workpieces 10 includes at least one protruding portion that protrudes downward when each of the workpieces 10 is stacked as the workpiece stack 21. The protruding portion is a portion that is configured with a U-shaped cross section by the first sheet portion 11 and a plurality of the second sheet portions 12.

In detail, the deformation device 150 of the second embodiment is provided on a tip portion (rod 51) of the robot hand 33 via the pivot 52. The deformation device 150 includes a pushing portion 153 capable of pushing the specific second sheet portion 12A (second sheet portion 12) of the upper workpiece 10U in the sheet surface direction Rt, and the actuator 155 capable of driving the specific second sheet portion 12A portion between an elastic deformation state and a deformation release state by pushing and pulling the pushing portion 153 in the sheet surface direction Rt.

The actuator 155 includes a cylinder 161 connected to the robot hand 33 (rod 51); a piston 164 that partitions the inside of the cylinder 161 into a space portion 162 and a spring chamber 163; a piston rod 165 connecting the piston 164 and the pushing portion 153; and a return spring 166 stored in the spring chamber 163. The return spring 166 is composed of a compression spring.

The space portion 162 is connected to a discharge port of a compressor 157 and a suction port of a vacuum pump 159 via the second switching valve 56. The second switching valve 56 maintains the space portion 162 in a vacuum or negative pressure state by normally communicating between the suction port of the vacuum pump 159 and the space portion 162. For this reason, the piston 164 is retreated by the biasing forces of the return spring 166, and separates the pushing portion 153 away from the specific second sheet portion 12A via the piston rod 165.

Meanwhile, the second switching valve 56 receives a signal from the control unit 72, and switches the space portion 162 to a pressurized state using pressurized air from the compressor 157. For this reason, the piston 164 advances against the biasing force of the return spring 166, and can press the pushing portion 153 against the specific second sheet portion 12A via the piston rod 165.

Incidentally, the actuator 155 may be configured to press the pushing portion 153 against the specific second sheet portion 12A against the biasing force of a pressing spring 154, and can be configured as, for example, a solenoid.

The second embodiment also has the actions and effects of the first embodiment, in addition to actions and effects of the second embodiment.

### Third Embodiment

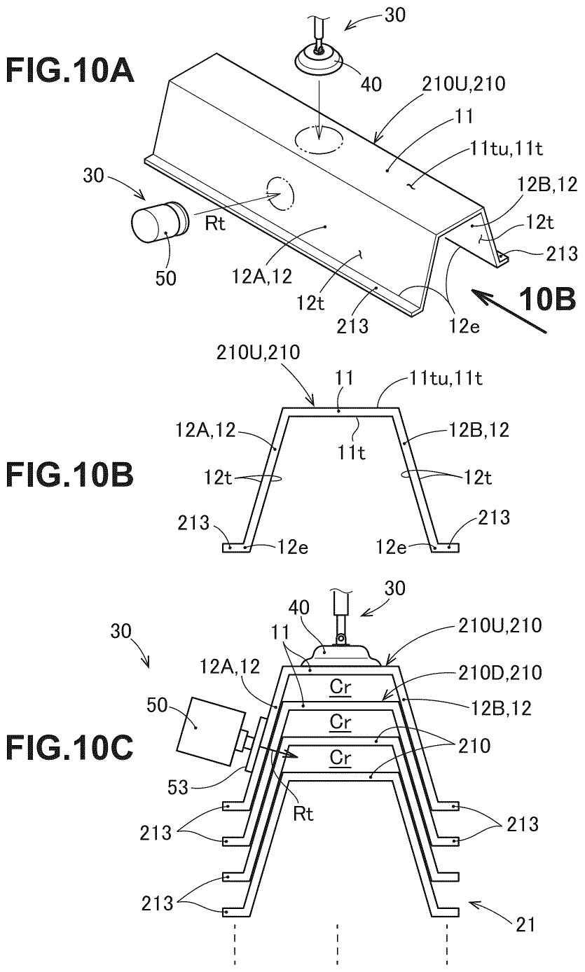

A workpiece 210 of a third embodiment will be described with reference to FIG. 10. FIG. 10 corresponds to FIG. 1. In the third embodiment, the workpiece take-out device 30 of the first embodiment illustrated in FIG. 1 to FIG. 8 is used as it is.

The workpiece 210 of the third embodiment is characterized by being configured with a hat-shaped cross section by adding a folded flange 213 for joining to each of the end portions 12e of the plurality of second sheet portions 12 of the workpiece 10 of the first embodiment illustrated in FIG. 1 to FIG. 8, and the other basic configurations are common to the workpiece 10 according to the first embodiment. The same reference signs are used for portions that are common to the workpiece 10 and the workpiece take-out device 30 according to the first embodiment, and detailed description thereof will be omitted.

In detail, the workpiece 210 of the third embodiment is used as, for example, a vehicle body panel such as a side sill inner or a side sill outer. The workpiece 210 includes at least one protruding portion that protrudes upward when the workpiece 210 is stacked as the workpiece stack 21 on the cart 22 (refer to FIG. 1C). Similarly to the first embodiment, the protruding portion is a portion that is configured with a U-shaped cross section by the first sheet portion 11 and the plurality of second sheet portions 12. Each of the end portions 12e of the plurality of second sheet portions 12 (the end portions 12e opposite to the first sheet portion 11) includes the folded flange 213 that is folded outward. The folded flange 213 increases the rigidity of the second sheet portion 12.

Here, among the workpieces 210 (vehicle body panels 210) stacked as the workpiece stack 21, the uppermost workpiece 210 located at the upper end of the workpiece stack 21 is particularly referred to as an “upper workpiece 210U (highest-positioned workpiece 210U)”, and the overlapping workpiece 10 immediately below the upper workpiece 210U is particularly referred to as a “lower workpiece 210D (lower-positioned workpiece 210D)”.

The gap Cr in the up-down direction is provided between the first sheet portion 11 of the upper workpiece 210U and the first sheet portion 11 of the lower workpiece 210D.

The suction unit 40 is positioned to be able to suction and lift the upper surface 11tu of the first sheet portion 11 of the upper workpiece 210U of the workpiece stack 21.

The deformation device 50 is positioned to be able to elastically deform one (specific second sheet portion 12A) of the plurality of second sheet portions 12 of the upper workpiece 210U of the workpiece stack 21 in the sheet surface direction Rt of the second sheet portion 12A, the plurality of second sheet portions 12A including the folded flanges 213.

By elastically deforming one second sheet portion 12A (specific second sheet portion 12A) using the deformation device 50, the elastic deformation is transmitted to the other second sheet portion 12B (remaining second sheet portion 12B) corresponding to the second sheet portion 12A. For this reason, the upper workpiece 210U and the lower workpiece 210D can be easily separated from each other.

Incidentally, third embodiment can also be applied to a case where a plurality of the workpieces 210 constituting the workpiece stack 21 are oriented upside down as the orientation of the plurality of workpieces 10 of the second embodiment illustrated in FIG. 9. In addition, in the third embodiment, the deformation device 150 of the second embodiment (refer to FIG. 9) may be adopted instead of the deformation device 50.

The third embodiment also has the actions and effects of the first and second embodiments, in addition to actions and effects of the third embodiment.

### Fourth Embodiment

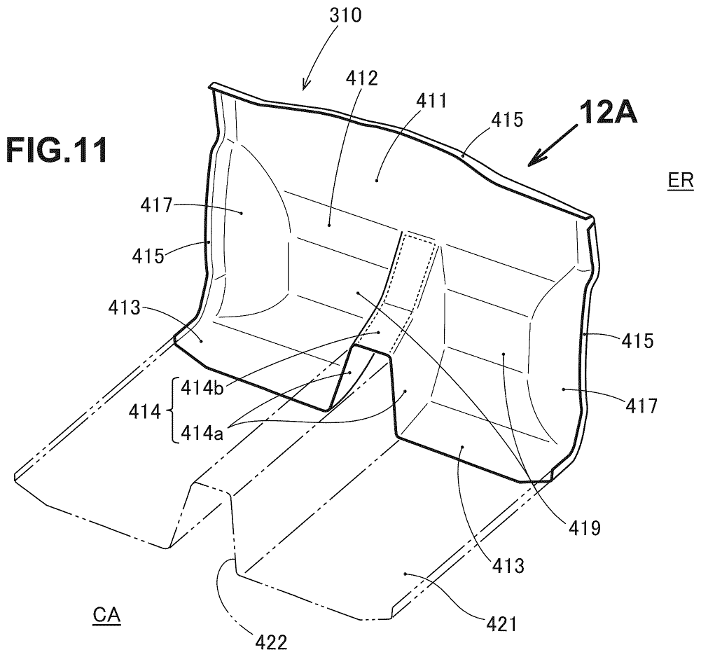

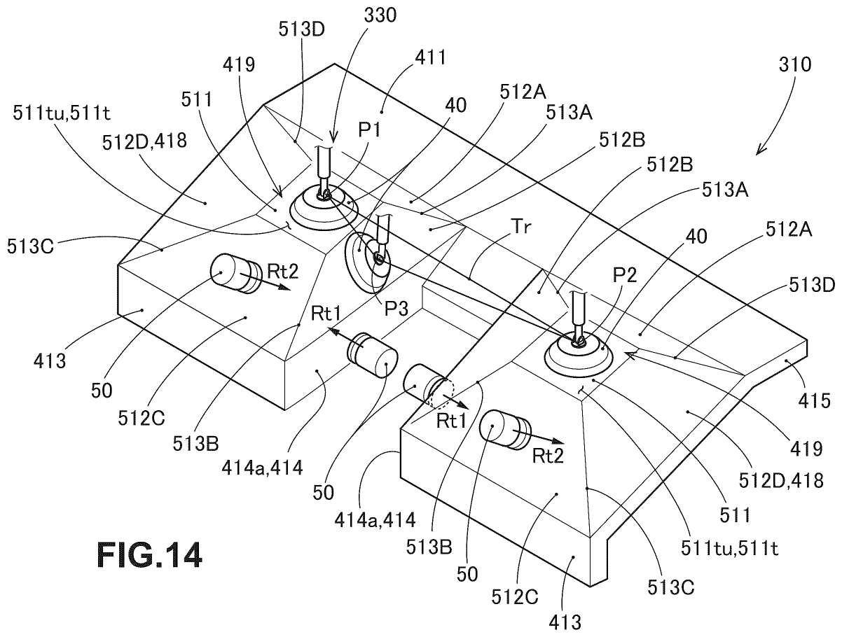

A workpiece take-out device 330 of a fourth embodiment (refer to FIG. 14) and a plurality of workpieces 310 that are taken out by the workpiece take-out device 330 will be described with reference to FIG. 11 to FIG. 16. The same reference signs are used for portions that are common to the workpiece 10 and the workpiece take-out device 30 according to the first embodiment, and detailed description thereof will be omitted.

As illustrated in FIG. 11, the workpiece 310 of the fourth embodiment is a press-formed article made of a metal sheet similarly to the workpiece 10 of the first embodiment, and can be used as, for example, a vehicle body panel such as a dashboard lower constituting a part of a vehicle body. The dashboard lower can partition a passenger compartment CA and an engine compartment ER (power compartment ER) of a vehicle off from each other. The workpiece 310 may be reworded as the “dashboard lower 310” as appropriate.

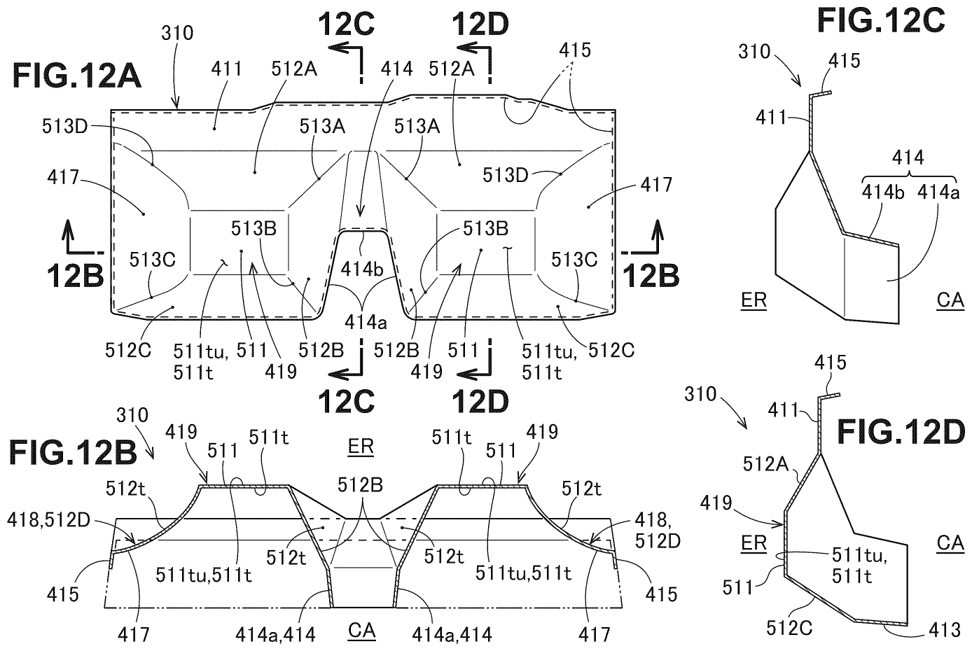

Referring also to FIG. 12A to FIG. 12D, FIG. 12A illustrates a configuration of the dashboard lower 310 in FIG. 11 when viewed from an engine compartment ER side (in the direction of arrow 12A in FIG. 11).

The dashboard lower 310 is manufactured by integrally press-forming a board upper half portion 411 having a vertical sheet shape, a board lower half portion 412 (refer to FIG. 11) extending downward from a lower end of the board upper half portion 411, a floor front portion 413 extending from a lower end of the board lower half portion 412 toward a passenger compartment CA side, a tunnel portion 414 extending from the center of the board lower half portion 412 in a width direction toward the passenger compartment CA side. Edges of the board upper half portion 411 and edges of the board lower half portion 412 include joining flanges 415 that are folded outward. The joining flanges 415 increase the rigidity of the dashboard lower 310.

The floor front portion 413 is joined to a front end of a floor panel 421 on the passenger compartment CA side, which is indicated by an imaginary line. A floor tunnel 422 extending in a front-rear direction is integrally formed at the center of the floor panel 421 in the width direction. The tunnel portion 414 is joined to a front end of the floor tunnel 422.

The tunnel portion 414 is a portion extending from an upper end of the board lower half portion 412 toward the passenger compartment CA side along the floor front portion 413, and bulging toward the passenger compartment CA side. Further, the tunnel portion 414 is configured with a U-shaped cross section that is open on an engine compartment ER side and downward. In detail, the tunnel portion 414 is composed of left and right side sheets 414a and 414a having a vertical sheet shape and a top sheet 414b having a horizontal sheet shape. The left and right side sheets 414a and 414a having a vertical sheet shape stand up from the board lower half portion 412 and the floor front portion 413 toward the passenger compartment CA side, and sheet surfaces face sideways. A sheet surface of the top sheet 414b faces in the up-down direction to close a space between upper ends of the side sheets 414a and 414a.

A pair of wheel housing rear portions 417 and 417 bulging in a curved shape toward the passenger compartment CA and a pair of bulging portions 419 and 419 bulging toward the engine compartment ER are integrally formed on the board lower half portion 412.

The pair of wheel housing rear portions 417 and 417 are located on both sides of the board lower half portion 412 in the width direction, and form rear portions of wheel housing. Therefore, a pair of housing recessed portions 418 and 418 that are recessed in a curved shape toward the passenger compartment CA side are formed in the board lower half portion 412 (refer also to FIG. 12C).

The pair of bulging portions 419 and 419 (toe board portions 419 and 419) are formed from the tunnel portion 414 to the pair of wheel housing rear portions 417 and 417, and bulge toward the engine compartment ER, so that spaces around the feet of occupants seated in the passenger compartment CA are expanded.

As is clear from the above description, the dashboard lower 310 includes two bulging portions 419 and 419 having a U-shaped cross section on the left and right with the tunnel portion 414 interposed therebetween, the tunnel portion 414 having an inverted U-shaped cross section and located at the center in the width direction.

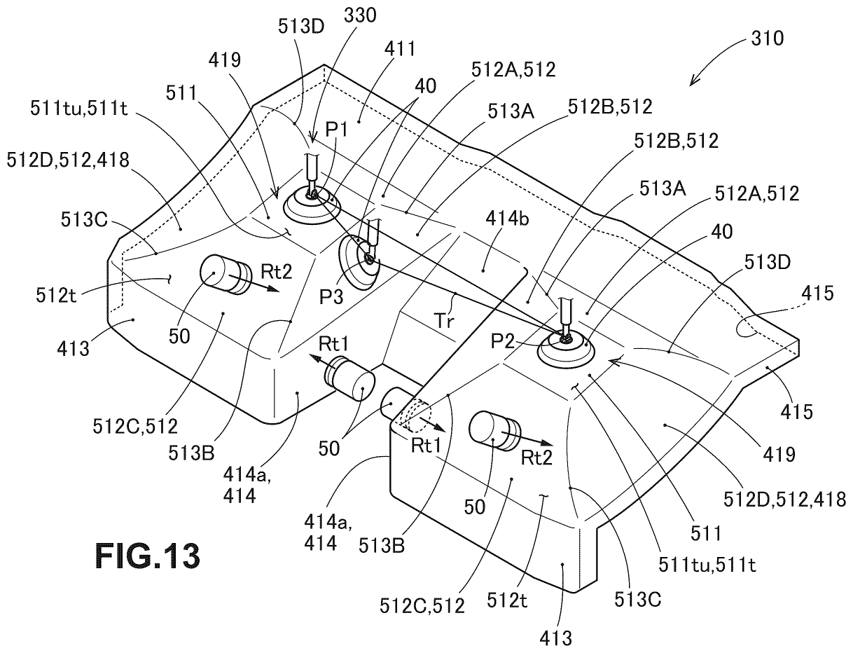

Referring to FIG. 13 and FIG. 14, FIG. 13 illustrates the dashboard lower 310 from the engine compartment ER side. FIG. 14 further conceptually illustrates the dashboard lower 310 in FIG. 13. FIG. 13 and FIG. 14 illustrate a configuration in which the pair of bulging portions 419 and 419 (protruding portions 419 and 419) bulge toward the engine compartment ER on the board lower half portion 412. The protruding portions 419 and 419 are bilaterally symmetrical with respect to the tunnel portion 414. In such a manner, the dashboard lower 310 includes at least two protruding portions 419 and 419 spaced apart from each other along the sheet surface.

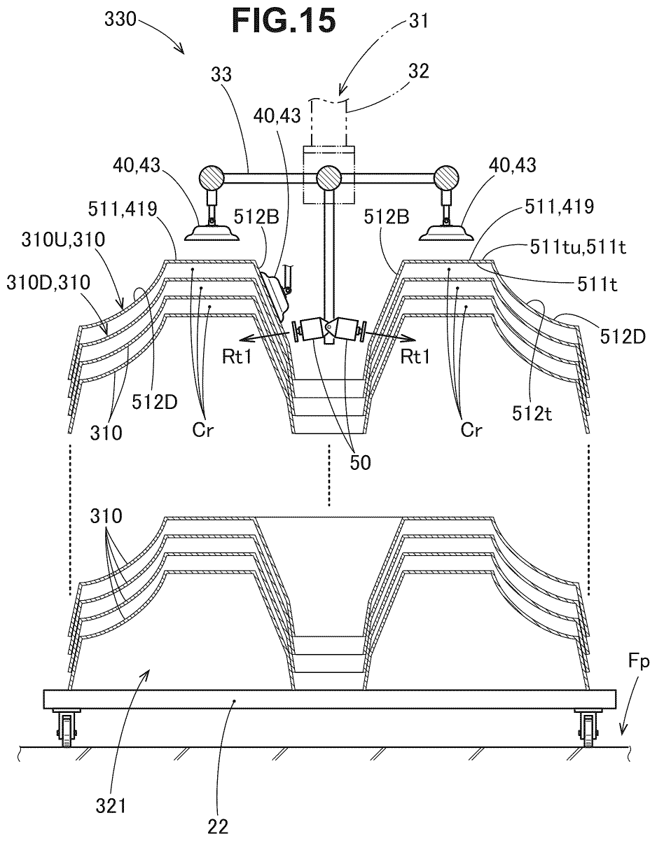

Hereinafter, the dashboard lower 310 in a state where the two protruding portions 419 and 419 face upward similarly to a state where the dashboard lower 310 is loaded on the cart 22 (refer to FIG. 15) will be described with reference to FIG. 13 and FIG. 14. Each of the protruding portions 419 has a shape having at least one corner portion when viewed from above, and is formed in, for example, a polygonal shape such as a quadrilateral shape. Each of the protruding portions 419 is a portion that is configured with a U-shaped cross section (refer to FIG. 12B and FIG. 12D) by one first sheet portion 511 of which a sheet surface 511t faces in the up-down direction, and a plurality (for example, four) of second sheet portions 512 which extend from the first sheet portion 511 in the up-down direction and of which sheet surfaces 512t face sideways.

Here, when distinguishing is made between the four second sheet portions 512, in order to facilitate understanding of description, an alphabetical reference sign is added to the end of each reference sign. Namely, among the four second sheet portions 512, the first is referred to as a second sheet portion 512A, the second is referred to as a second sheet portion 512B, the third is referred to as a second sheet portion 512C, and the fourth is referred to as a second sheet portion 512D.

The 1st second sheet portion 512A extends from the lower end of the board upper half portion 411 to an edge of the first sheet portion 511. The 2nd second sheet portion 512B extends from the side sheet 414a of the tunnel portion 414 and the side sheet 414a to an edge of the first sheet portion 511. The 3rd second sheet portion 512C extends from the floor front portion 413 to an edge of the first sheet portion 511. The 4th second sheet portion 512D is composed of the housing recessed portion 418. The housing recessed portion 418 is an arc-shaped sheet extending from the folded flange 415 to an edge of the first sheet portion 511. Each of the second sheet portions 512A to 512D includes an inclined sheet, an arc-shaped sheet, and a vertical sheet. In such a manner, each of the second sheet portions 512A to 512D may include a bent portion. For example, the 2nd second sheet portion 512B may include the side sheet 414a of the tunnel portion 414. The 3rd second sheet portion 512C may include the floor front portion 413.

Each of four corner portions 513 is located between the second sheet portions 512 and 512 adjacent to each other. Among the four corner portions 513, a corner portion 513A between two second sheet portions 512A and 512B adjacent to each other is referred to as the “first corner portion 513A”, a corner portion 513B between two second sheet portions 512B and 512C adjacent to each other is referred to as the “second corner portion 513B”, a third corner portion 513C between two second sheet portions 512C and 512D adjacent to each other is referred to as the “third corner portion 513C”, and a corner portion 513D between two second sheet portions 512D and 512A adjacent to each other is referred to as the “fourth corner portion 513D”.

As illustrated in FIG. 12D, the protruding portions 419 are configured with a U-shaped cross section by the first sheet portion 511, the 1st second sheet portion 512A, and the 3rd second sheet portion 512C. In addition, as illustrated in FIG. 12B, the protruding portions 419 are configured with a U-shaped cross section by the first sheet portion 511, the 2nd second sheet portion 512B, and the 4th second sheet portion 512D.

As illustrated in FIG. 12B and FIG. 15, a plurality of the dashboard lowers 310 made of a sheet material are stacked on the cart 22 with each of the protruding portions 419 and 419 facing upward. A workpiece stack 321 is composed of the plurality of dashboard lowers 310 that are stacked in the up-down direction.

Here, of the sheet surfaces 511t and 511t on both sides of the first sheet portion 511, particularly the sheet surface 511t on the upper side is referred to as an “upper surface 511tu (sheet surface 511tu on the upper side)” The sheet surface 511tu on the upper side of the first sheet portion 511 forms the upper surface 511tu on a protruding side of the protruding portion 419, and is in a horizontal state (including a substantially horizontal state) as illustrated in FIG. 15.

In addition, each of the workpieces 310 constituting the workpiece stack 321 is defined as follows. The uppermost dashboard lower 310 (workpiece 310) located at an upper end of the workpiece stack 321 is particularly referred to as an “upper workpiece 310U (highest-positioned workpiece 310U)”, and the overlapping workpiece 310 immediately below the upper workpiece 310U is referred to as a “lower workpiece 310D (lower-positioned workpiece 310D)”.

The gap Cr in the up-down direction is provided between the first sheet portion 511 of the upper workpiece 310U and the first sheet portion 511 of the lower workpiece 310D.

As illustrated in FIG. 13 to FIG. 15, the workpiece take-out device 330 of the fourth embodiment includes a plurality of the suction units 40 and a plurality of the deformation devices 50 corresponding to a plurality of the protruding portions 419 of the upper workpiece 310U.

For example, the workpiece take-out device 330 can cause at least two suction units 40 and 40 to individually suction the upper surfaces 511tu and 511tu of the protruding portions 419 and 419 and to lift the upper workpiece 310U.

Preferably, the workpiece take-out device 330 is configured to cause three suction units 40 to suction and lift the upper workpiece 310U. In this case, as illustrated in FIG. 13 and FIG. 14, when the upper workpiece 310U (dashboard lower 310) is viewed from above, vertices P1 to P3 of a triangle Tr are assumed (set in advance). For example, the first vertex P1 and the second vertex P2 of the triangle Tr are set at positions on the upper surfaces 512tu and 512tu of the two protruding portions 419 and 419. The position of the remaining third vertex P3 is set in consideration of suppressing lateral vibration of the upper workpiece 310U that is lifted. For example, the position of the third vertex P3 is set at an upper portion of the 2nd second sheet portion 512B.

For example, the workpiece take-out device 330 can elastically deform the second sheet portions 512 and 512 of the protruding portions 419 and 419 individually using at least two deformation devices 50 and 50. Incidentally, among four deformation devices 50 and 50, since the tunnel portion 414 is narrow, the deformation device 150 of the second embodiment (refer to FIG. 9) can be adopted as the deformation device 50 for the tunnel portion 414. In addition, in the deformation device 150 of the second embodiment, a single actuator 155 can be used as a linear rail (connecting member) that extends the piston rod 165 toward the other second sheet portions 12B, and pushing portions 153 and 153 can be attached to both ends, and can push and pull the left and right second sheet portions 414a and 414a (refer to FIG. 14) of the tunnel portion 414.

Preferably, the workpiece take-out device 330 is configured such that at least two deformation devices 50 and 50 are disposed for each of the protruding portions 419 and 419 of the upper workpiece 310U. For example, the deformation devices 50 and 50 are arranged in two different directions to be able to elastically deform two second sheet portions 512 and 512 in respective sheet surface directions Rt1 and Rt2, which are adjacent to each other via the second corner portions 513B and 513B (bent portions 513B and 513B, ridges 513B and 513B).

As one example, the deformation devices 50 and 50 are disposed for the 2nd second sheet portion 512B and the 3rd second sheet portion 512C, respectively, which are adjacent to each other. A sheet surface direction of the 2nd second sheet portion 512B is Rt1, and a sheet surface direction of the 3rd second sheet portion 512C is Rt2.

Here, among the plurality of second sheet portions 512 of the upper workpiece 310U, the second sheet portions 512B and 512C that are elastically deformed in the sheet surface direction Rt1 and Rt2 of the second sheet portions 512 by the deformation devices 50 and 50 are referred to as the “specific second sheet portions 512B and 512C”, and the other second sheet portions 512A and 512D confronting the specific second sheet portions 512B and 512C are referred to as the “remaining second sheet portions 512A and 512D”.

Next, the operation (workpiece take-out method) of the workpiece take-out device 330 of the fourth embodiment will be described.

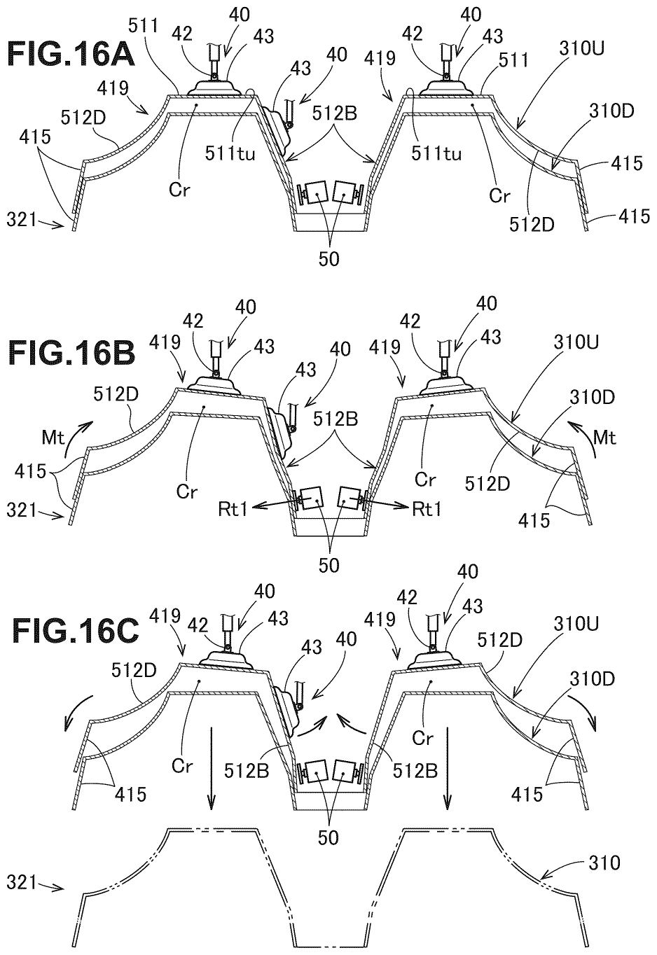

First, as illustrated in FIG. 14 and FIG. 16A, two suction units 40 descend and suction the upper surfaces 511tu while pushing down the upper surfaces 511tu of the first sheet portions 511 of the upper workpiece 310U. At the same time, another suction unit 40 suctions the sheet surface 512t of the 2nd second sheet portion 512B.

At the same time or next, the specific second sheet portion 512C of each of the protruding portions 419 is elastically deformed individually by the pressing spring 54 (refer to FIG. 4) of the corresponding deformation device 50. As a result, a lower end of the floor front portion 413 (refer to FIG. 14) that is continuous with the specific second sheet portion 512C comes into contact with the lower workpiece 310D to become a contact portion, and with the contact portion as a fulcrum, the specific second sheet portion 512C elastically deforms in a direction in which the gap Cr between the upper workpiece 310U and the lower workpiece 310D is eliminated. The elastic deformation is linked via the suction unit 40, and the second sheet portion 512A confronting the specific second sheet portion 512C elastically deforms to be lifted from the lower workpiece 310D, namely, in a direction away from the lower workpiece 310D. Since the board upper half portion 411 that is continuous with the second sheet portion 512A is also lifted, the joining flange 415 can be released from the fitting to the lower workpiece 310D.

At the same time or next, as illustrated in FIG. 14 and FIG. 16B, the specific second sheet portion 512B of each of the protruding portions 419 is elastically deformed individually by the corresponding deformation device 50. As a result, the specific second sheet portion 512B elastically deforms the confronting second sheet portion 512D in the same manner.

In such a manner, due to the pressing force (the strong biasing force of the pressing spring 54 illustrated in FIG. 4) acting from each of the deformation devices 50 on the specific second sheet portions 512B and 512C, the force moments Mt and Mt (refer to FIG. 16B) acts on the upper workpiece 310U via the suction units 40 (strictly speaking, the pivots 42). For this reason, the entirety of the upper workpiece 310U elastically deforms in the sheet surface directions Rt1 and Rt2, together with the specific second sheet portions 512B and 512C.

At this time, the elastic deformation amounts of the two specific second sheet portions 512B (including tunnel portion 414) and 512C are added (increased). Even when the joining flange 415 of the upper workpiece 310U, including the corner portion extending from the board upper half portion 411 to the second sheet portion 512D, the board upper half portion 411 being connected to the second corner portion 513D, is fitted up and down to the lower workpiece 310D, the state of fitting is easily removed. Namely, the upper workpiece 310U and the lower workpiece 310D can be easily separated from each other.

Next, as illustrated in FIG. 14 and FIG. 16C, after the upper workpiece 310U is lifted by the suction units 40, the deformation devices 50 are separated away from the specific second sheet portions 512B and 512C. As a result, the upper workpiece 310U that is lifted swings back toward the side of the specific second sheet portions 512B and 512C as a whole to return to the original horizontal state, and the elastic deformation state also returns to the original state. For this reason, even when the state of fitting is strong and separation cannot be made, the state of fitting of the lower workpiece 310D fitted to the upper workpiece 310U, including the corner portions 513A to 513D, is easily removed. The lower workpiece 310D is removed and falls from the upper workpiece 310U.

In such a manner, the workpiece take-out device 330 can reliably take out only the upper workpieces 310U one by one from the top of the workpiece stack 321.

The fourth embodiment also has the actions and effects of the first to third embodiments, in addition to actions and effects of the fourth embodiment. In the fourth embodiment, the deformation device 150 of the second embodiment (refer to FIG. 9) may be adopted instead of the deformation device 50 that is disposed in a narrow space of the tunnel portion 414.

The workpieces 10, 210, 310 and the workpiece take-out device 30, 130, 330 of the first to fourth embodiments described above will be summarized as below.

Referring to FIG. 1, FIG. 9, FIG. 10, and FIG. 15, in a first aspect, the workpiece stack 21, 321 is composed of the plurality of workpieces 10, 210, 310 stacked in the up-down direction with the gaps Cr between the workpieces 10, 210, 310. Each of the plurality of workpieces 10, 210, 310 is composed of a formed (shaped) sheet material, for example, a sheet material shaped by press-forming a steel sheet, injection-molding resin, or the like, and includes a portion configured with a U-shaped cross section by at least one first sheet portion 11, 511 of which the sheet surface 11t, 511t faces in the up-down direction, and the plurality of second sheet portions 12, 512 which extend from the first sheet portion 11, 511 in the up-down direction and of which the sheet surfaces 12t, 512t face sideways.

The workpiece take-out device 30, 130, 330 is configured to be able to take out the plurality of workpieces 10, 210, 310 one by one in order from the top of the workpiece stack 21, 321. The workpiece take-out device 130, 330 includes the robot hand 33 provided in the robot 31; at least one suction unit 40 provided on the robot hand 33, and capable of suctioning and lifting the first sheet portion 11, 511 of the workpiece 10U, 210U, 310U located at the upper end of the workpiece stack 21, 321; and at least one deformation device 50 provided on the robot hand 33, and capable of elastically deforming at least one of the plurality of second sheet portions 12, 512 of the workpiece 10U, 210U, 310U in the sheet surface direction Rt, Rt1 and Rt2 of the second sheet portion 12, 512, the workpiece 10U, 210U, 310U being located at the upper end.

For this reason, the workpieces 10, 210, 310 that are taken out one by one from the workpiece stack 21, 321 by the workpiece take-out device 30, 130, 330 are composed of sheet materials, so that the workpieces 10, 210, 310 can be elastically deformed. The workpiece 10, 210, 310 includes a portion configured with a U-shaped cross section by the first sheet portion 11, 511 of which the sheet surface 11t, 511t faces in the up-down direction, and the second sheet portions 12, 512 which extends from the first sheet portion 11, 511 in the up-down direction and of which the sheet surfaces 12t, 512t face sideways. The second sheet portions 12 and 12, 512 and 512 of the workpieces 10, 210, 310 stacked in the up-down direction tend to strongly fit to each other due to a springback in press-forming or the like (which is noticeable in the case of cold pressing of a high-tensile strength steel sheet), a frictional force, the engagement of complex recesses and protrusions in design, or the like.

Meanwhile, in the invention, even when the upper workpiece 10U, 210U, 310U to be lifted is fitted to the lower workpiece 10D, 210D, 310D, the deformation device 50 pushes one second sheet portion 12, 512 of the upper workpiece 10U, 210U, 310U in the sheet surface direction Rt to be elastically deformed with the contact portion (contact point) with the lower workpiece 10D, 210D, 310D as a fulcrum, and the elastic deformation is linked to the other second sheet portion 12, 512 via the suction unit 40, so that the state of fitting of the lower workpiece 10D, 310D to the second sheet portion 12, 512 is easily removed. For this reason, only the upper workpiece 10U, 210U, 310U can be easily lifted by the suction unit 40 suctioning the first sheet portion 11, 511. Even when the workpieces 10, 210, 310 have a complex shape, the workpieces 10, 210, 310 can be more reliably taken out one by one.

Referring to FIG. 2, FIG. 5, FIG. 9, FIG. 10, and FIG. 15, in a second aspect, the workpiece take-out device 30, 130, 330 described in the first aspect includes the control unit 72 that controls the robot hand 33, the suction unit 40, and the deformation device 50, 150. The control unit 72 is configured at least to drive the deformation device 50, 150 to elastically deform the second sheet portion 12, 512 of the workpiece 10U, 210U, 310U located at the upper end of the workpiece stack 21, 321 when the suction unit 40 suctions the first sheet portion 11, 511 of the workpiece 10U, 210U, 310U located at the upper end, and to control the deformation device 50, 150 to separate away from the second sheet portion 12, 512 when the suction unit 40 lifts the first sheet portion 11, 511 (refer to step S05 to step S08 in FIG. 5).

For this reason, when the suction unit 40 suctions and pushes down the first sheet portion 11, 511, the deformation device 50, 150 elastically deforms the second sheet portion 12, 512. Thereafter, when the suction unit 40 lifts the first sheet portion 11, 511, the deformation device 50, 150 separates from the second sheet portion 12, 512. Even if the upper workpiece 10U, 210U, 310U to be lifted is fitted to the lower workpiece 10D, 210D, 310D, when the upper workpiece 10U, 210U, 310U is lifted while the second sheet portion 12, 512 is elastically deformed, the deformation device 50, 150 is controlled to separate away from the second sheet portion 12, 512, so that the lower workpiece 10D, 210D, 310D falls due to its own weight, and only the upper workpiece 10U, 210U, 310U can be efficiently taken out.

Referring to FIG. 1C, FIG. 2, FIG. 5, FIG. 9, FIG. 10, and FIG. 15, in a third aspect, in the workpiece take-out device 30, 130, 330 described in the second aspect, the uppermost workpiece 10 that is lifted from the workpiece stack 21, 321 by the suction unit 40 is referred to as the upper workpiece 10U, 210U, 310U (highest-positioned workpiece 10U, 210U, 310U), and the overlapping workpiece 10 immediately below the upper workpiece 10U, 210U, 310U is referred to as the lower workpiece 10D, 210D, 310D (lower-positioned workpiece 10D, 210D, 310D). The control unit 72 is configured to control the deformation device 50, 150 to continue the elastic deformation operation of the second sheet portion 12, 512 until it determined that the lifting of the upper workpiece 10U, 210U, 310U to the separation position Ls1 (refer to FIG. 1C) with respect to the lower workpiece 10D, 210D, 310D is completed (refer to step S09 to step S12 in FIG. 5 and FIG. 6).

For this reason, until the suction unit 40 completes the lifting of the first sheet portion 11, 511 of the upper workpiece 10U, 210U, 310U to the separation position Ls1 (the height Ls1 at which a next take-out can be performed even after separation), the deformation device 50, 150 continues to elastically deform the second sheet portion 12, 512 of the upper workpiece 10U, 210U, 310U. For this reason, the lower workpiece 10D easily falls due to inertia in response to the lifting operation (movement) of the upper workpiece 10U. Since the separation position Ls1 is a position where the lower workpiece 10D, 210D, 310D is mounted at the original position without damage even when the state of fitting is released, the take-out of the next workpiece 10, 210, 310 can continue automatically without any problem.

Referring to FIG. 2, FIG. 5, FIG. 9, FIG. 10, and FIG. 15, in a fourth aspect, the workpiece take-out device 30, 130, 330 described in the second and third aspects further includes the 3D vision sensor 71 provided on the robot hand 33 to be able to detect (recognize) the position and the angle of the workpiece 10, 210, 310 located at the upper end of the workpiece stack 21, 321. The control unit 72 is configured to correct the posture of the robot hand 33 based on the position and the angle of the 10U, 210U, 310U located at the upper end, which are detected (recognized) by the 3D vision sensor 71 (refer to step S02 to step S04 in FIG. 5).

In such a manner, by correcting the posture of the robot hand 33, the suction unit 40 and the deformation device 50, 150 provided on the robot hand 33 can be accurately moved to an appropriate suction position and an appropriate elastic deformation position of the upper workpiece 10U, 210U, 310U.

Referring to FIG. 2, FIG. 5, FIG. 9, FIG. 10, and FIG. 15, in a fifth aspect, in the workpiece take-out device 30, 130, 330 described in the first to fourth aspects, the workpiece 210, 310 is a vehicle body panel constituting a part of a vehicle body, and includes at least one protruding portion that protrudes upward when the workpiece 210, 310 is stacked as the workpiece stack 21, 321. The protruding portion is a portion configured with a U-shaped cross section by the first sheet portion 11, 511 and the plurality of second sheet portions 12 and 12, 512 and 512. The end portions 12e and 12e of the plurality of second sheet portions 12 and 12, 512 and 512 include the respective folded flanges 213 and 213, 415 and 415. The suction unit 40 is configured to be able to suction and lift the first sheet portion 11, 511 composed of the protruding portion of the workpiece 10U, 210U, 310U located at the upper end of the workpiece stack 21, 321. The deformation device 50, 150 is positioned to be able to push and elastically deform one of the plurality of second sheet portions 12 and 12, 512 of the workpiece 10U, 210U, 310U in the sheet surface direction Rt, Rt1 and Rt2 of the second sheet portion 12, 512, the workpiece 10U, 210U, 310U being located at the upper end.

The folded flange 213, 415 increases the rigidity of the second sheet portion 12, 512. For this reason, in a state where the plurality of vehicle body panels 210, 310 (workpieces 210, 310) overlap each other up and down on the cart 22 with the gaps Cr therebetween, the second sheet portions 12, 512 of the upper vehicle body panel 210U, 310U and the second sheet portions 12, 512 of the lower vehicle body panel 210D, 310D are likely to be strongly fitted to each other at portions close to the folded flanges 213 and 213, 415 with high rigidity. Further, when the upper surface 11tu, 511tu on the protruding side of the protruding portion of the upper vehicle body panel 210U, 310U (upper surface 11tu, 511tu of the first sheet portion 11, 511) is pressed downward for suction, the gap Cr up and down between the upper surface 11tu, 511tu on the protruding side of the protruding portion 419 of the upper vehicle body panel 210U, 310U and the upper surface 11tu, 511tu on the protruding side of the protruding portion of the lower vehicle body panel 210D, 310D is eliminated or reduced. For this reason, the second sheet portion 12, 512 of the upper vehicle body panel 210U, 310U and the second sheet portion 12, 512 of the lower vehicle body panel 210D, 310D are likely to be strongly fitted to each other at a portion close to the folded flange 213, 415 with high rigidity.

Meanwhile, in the invention, one of the second sheet portions 12A, 512B and 512C of which the rigidity is increased by the folded flanges 213, 415 is elastically deformed, and the elastic deformation is transmitted to the corresponding other second sheet portions 12B, 512A and 512D, so that the upper vehicle body panel 210U, 310U and the lower vehicle body panel 210D, 310D can be easily separated from each other.

Referring FIG. 13 and FIG. 15, in a sixth aspect, in the workpiece take-out device 330 described in the first to fifth aspects, the workpiece 310 includes at least four second sheet portions 512. The deformation devices 50 (refer to FIG. 13) are arranged in two different directions Rt1 and Rt2 to be able to push and elastically deform two second sheet portions 512B (including the tunnel portion 414) and 512C (including the floor front portion 413) of the workpiece 310U (refer to FIG. 15) located at the upper end of the workpiece stack 321, the two second sheet portions 512B and 512C being adjacent to each other via the ridge 513B (refer to FIG. 13), in the directions of the respective sheet surfaces 512t and 512t.

For this reason, the two second sheet portions 512B and 512C adjacent to each other can be elastically deformed individually by two deformation devices 50. Therefore, when the sheet surfaces 512t and 512t of the two second sheet portions 512B and 512C are elastically deformed at the same time, the elastic deformation amount of the two second sheet portions 512B and 512C are added (increased), and even when the joining flanges 415 that are bent in a plan view to span the corner portion 513D between the corresponding two second sheet portion 512A and 512D adjacent to each other and the corner portion of the 414 on an extension line are fitted to each other up and down, the workpieces 310U and 310D can be easily separated from each other. In addition, by elastically deforming the sheet surfaces 512t and 512t of the two second sheet portions 512B and 512C at the same time or alternately, the entirety of the workpiece 310 can be deformed in a complex (irregular) manner. For this reason, the upper workpiece 310U and the lower workpiece 310D can be effectively removed from each other by deforming the strongly fitted portions thereof largely, continuously, or with varying strength.

Referring to FIG. 4, FIG. 8, and FIG. 14, in a seventh aspect, in the workpiece take-out device 30, 130, 330 described in the first to sixth aspects, the deformation device 50, 150 includes the vibrator 58 that applies vibration to the second sheet portions 12, 512 in the sheet surface directions Rt, Et1 and Rt2, at least in a state where the suction unit 40 lifts the first sheet portion 11, 511 of the workpiece 10U, 210U, 310U located at the upper end of the workpiece stack 21, 321.

For this reason, by applying vibration to fitted portions between the upper workpiece 10U, 210U, 310U and the lower workpiece 10D, 210D, 310D, the release of the fitted portions between the upper workpiece 10U, 210U, 310U and the lower workpiece 10D, 210D, 310D can be promoted.

Referring to FIG. 13 and FIG. 15, in an eighth aspect, in the workpiece take-out device 330 described in the first to seventh aspect, the vertices P1 to P3 of the triangle Tr are assumed when the workpiece 310 is viewed from above. The suction units 40 are disposed at positions corresponding to the vertices P1 to P3 of the triangle on the workpiece 310U (refer to FIG. 15) located at the upper end of the workpiece stack 321.

Particularly, when a large workpiece 310 made of a thin sheet, such as a dashboard lower panel, is suctioned and lifted by one suction unit 40, the posture of the workpiece 310 is not stable, so that deformation of the second sheet portions 512B and 512C on a deformation device 50 side is difficult to be transmitted to the corresponding other second sheet portion 512A and 512D. Meanwhile, in the invention, since three positions (vertices P1 to P3 of the triangle Tr) on the workpiece 310 are suctioned and lifted by three suction units 40, respectively, the posture of the workpiece 310 is stable, and deformations of the second sheet portion 512B and 512C on the deformation device 50 side are easily transmitted to the corresponding other second sheet portion 512A and 512D. Moreover, lateral vibration of the workpiece 310 can also be suppressed. For this reason, the deformation devices 50 can elastically deform the second sheet portions 512 in the sheet surface direction Rt1 and Rt2, and can stably release fitted portions between the upper and lower workpieces 310 and 310, for example, the peripheral edges (joining flanges 415) extending from the upper half portion 411 to the corner portions 513A to 513D and the second sheet portions 512A to 512D.

Referring to FIG. 1, FIG. 4, FIG. 8, FIG. 10, FIG. 13, and FIG. 15, in a ninth aspect, in the workpiece take-out device 30, 130, 330 described in the first to eighth aspects, the workpiece 10, 210, 310 located at the upper end of the workpiece stack 21, 321 is referred to as the highest-positioned workpiece 10U, 210U, 310U, and the overlapping workpiece 10, 210, 310 immediately below the highest-positioned workpiece 10U, 210U, 310U is referred to as the lower-positioned workpiece 10D, 210D, 310D. Further, among the plurality of second sheet portions 12, 512 of the highest-positioned workpiece 10U, 210U, 310U, the second sheet portions 12, 512 that are elastically deformed in the sheet surface directions Rt, Rt1 and Rt2 by the deformation devices 50, 150 are referred to as the specific second sheet portions 12A, 512B and 512C, and the other second sheet portions 12, 512 excluding the specific second sheet portions 12A, 512B and 512C are referred to as the remaining second sheet portions 12B, 512A and 512D. The deformation amount de (refer to FIG. 4) by which the specific second sheet portions 12A, 512B and 512C are elastically deformed by the deformation devices 50, 150 is set to a size that can separate the state of fitting of the remaining second sheet portions 12B, 512A and 512D to the lower-positioned workpiece 10D, 210D, 310D.

For this reason, the deformation amount de by which the specific second sheet portions 12A, 512B and 512C are elastically deformed is set to a size that can separate the state of fitting of the corresponding remaining second sheet portions 12B, 512A and 512D, so that the state of fitting can be more reliably released.

Referring to FIG. 4, in a tenth aspect, in the workpiece take-out device 30, 330 described in the first to ninth aspects, the deformation device 50 includes the spring 54 (pressing spring 54) that applies a biasing force (pushing force) to the sheet surface 12t of the second sheet portion 12A of the workpiece 10U (upper workpiece 10U) located at the upper end of the workpiece stack 21, the biasing force being capable of bringing the entirety of the workpiece 10U, which is located at the upper end, into an elastic deformation state, together with the second sheet portion 12A (specific second sheet portion 12A) of the upper workpiece 10U, and the actuator 55 that releases the application of the biasing force of the spring 54.

The deformation device 50 can drive (exhaust) the actuator 55 upon a command from the control unit 72, and can bring the second sheet portion 12 into an elastic deformation state using the biasing force of the pressing spring 54 (may include the biasing force of the return spring 66). For this reason, at the same time that the suction unit 40 (refer to FIG. 1) suctions the first sheet portion 11, the second sheet portion 12 can be brought into an elastic deformation state by the deformation device 50, so that the fitted portions between the workpieces 10 and 10 can be released at the same time that the suction unit 40 performs suction.

Referring to FIG. 9, in an eleventh aspect, in the workpiece take-out device 130 described in the first to ninth aspects, the deformation device 150 includes the actuator 155 that can apply a pushing force to the sheet surface 12t of the second sheet portion 12A of the workpiece 10U (upper workpiece 10U) located at the upper end of the workpiece stack 21, the pushing force being capable of bringing the entirety of the workpiece 10U, which is located at the upper end, into an elastic deformation state, together with the second sheet portion 12A (specific second sheet portion 12A) of the upper workpiece 10U, and that can also release the application of the pushing force.

For this reason, the switching operation of the second sheet portion 12 between an elastic deformation state and a deformation release state by the deformation device 150 can be reliably performed by the actuator 155.

Referring to FIG. 1C, FIG. 4, FIG. 10, and FIG. 13, in a twelfth aspect, in the workpiece take-out device 30, 330 described in the first to ninth aspects, the deformation device 50 includes at least the spring mechanism 59 that elastically deforms the second sheet portions 12A, 512B and 512C in a state where the suction unit 40 suctions the first sheet portion 11, 511 and pushes down the first sheet portion 11, and the actuator 55 that separates the spring mechanism 59 away from the second sheet portion 12A in a state where the suction unit 40 lifts the first sheet portion 11, 511 (refer to step S05 to step S12 in FIG. 5).

When the suction unit 40 suctions the upper workpiece 10U, 210U, 310U, the suction unit 40 needs to press the upper workpiece 10U, 210U, 310U from above to come into close contact with the upper workpiece 10U, 210U, 310U. For this reason, the upper workpiece 10U, 210U, 310U and the lower workpiece 10D, 210D, 310D are pressed against each other by the suction unit 40, so that the second sheet portions 12 of the upper workpiece 10U, 210U, 310U tend to be strongly fitted to the second sheet portions 12 of the lower workpiece 10D, 210D, 310D. As a result, when the upper workpiece 10U, 210U, 310U is lifted, the lower workpiece 10D, 210D, 310D is also lifted.

Meanwhile, in the invention, in a state where the suction unit 40 suctions the first sheet portion 11, 511 and pushes down the first sheet portion 11, the spring mechanism 59 elastically deforms the second sheet portions 12A, 512B and 512C. Thereafter, in a state where the suction unit 40 lifts the first sheet portion 11, 511, the actuator 55 separates the spring mechanism 59 away from the second sheet portions 12A. Even if the upper workpiece 10U, 210U, 310U to be lifted is fitted to the lower workpiece 10D, 210D, 310D, when the upper workpiece 10U, 210U, 310U is lifted while the second sheet portion 12, 512 is elastically deformed, the deformation device 50 is controlled to separate away from the second sheet portion 12, 512, so that the lower workpiece 10D, 210D, 310D falls due to its own weight, and only the upper workpiece 10U, 210U, 310U can be efficiently taken out.

Incidentally, the invention is not limited to the embodiments as long as the actions and effects of the invention are achieved. For example, any two or more of the embodiments may be arbitrarily combined. The deformation device 150 of the second embodiment illustrated in FIG. 9 can be changed from the deformation device 50 of the other embodiments. In addition, the workpiece 10, 210, 310 is not limited to being configured as a vehicle body panel, and may be a press-formed article having a U-shaped cross-sectional shape. In addition, even when the workpiece 10, 210, 310 is configured as a vehicle body panel, the workpiece 10, 210, 310 is not limited to being a dashboard lower or a side sill, and may be configured as, for example, a floor panel that is large.

### INDUSTRIAL APPLICABILITY

The workpiece take-out device 30, 130, 330 of the invention is suitable for taking out the plurality of workpieces 10, 210, 310 one by one in order from the top, each of the workpieces 10, 210, 310 being composed of a vehicle body panel constituting a part of a vehicle body.

### EXPLANATIONS OF LETTERS OR NUMERALS

10, 210, 310 WORKPIECE
10U, 210U, 310U UPPER WORKPIECE (HIGHEST-POSITIONED WORKPIECE)
10D, 210D, 310D LOWER WORKPIECE (LOWER-POSITIONED WORKPIECE)
11, 511 FIRST SHEET PORTION
11t, 511t SHEET SURFACE OF FIRST SHEET PORTION
11tu, 511tu SHEET SURFACE ON UPPER SIDE OF FIRST SHEET PORTION (UPPER SURFACE ON PROTRUDING SIDE OF PROTRUDING PORTION)
12 SECOND SHEET PORTION
12A SPECIFIC SECOND SHEET PORTION
12B REMAINING SECOND SHEET PORTION
12e END PORTION OF SECOND SHEET PORTION
12t SHEET SURFACE OF SECOND SHEET PORTION
21, 321 WORKPIECE STACK
30, 130, 330 WORKPIECE TAKE-OUT DEVICE
31 ROBOT
33 ROBOT HAND
40 SUCTION UNIT
50, 150 DEFORMATION DEVICE
54 PRESSING SPRING
55, 155 ACTUATOR
58 VIBRATOR
59 SPRING MECHANISM
71 3D VISION SENSOR
72 CONTROL UNIT
213 FLANGE
Cr GAP
de DEFORMATION AMOUNT
Ls1 SEPARATION POSITION (FIRST REFERENCE HEIGHT)
P1 FIRST VERTEX OF TRIANGLE
P2 SECOND VERTEX OF TRIANGLE
P3 THIRD VERTEX OF TRIANGLE
Rt, Rt1, Rt2 SHEET SURFACE DIRECTION OF SECOND SHEET PORTION
Sp PUSH-DOWN AMOUNT OF UPPER WORKPIECE
Tr TRIANGLE

1. A workpiece take-out device that takes out a plurality of workpieces one by one in order from a top of a workpiece stack, the workpiece stack being composed of the plurality of workpieces stacked in an up-down direction with gaps between the workpieces, and each of the plurality of workpieces being composed of a formed sheet material, and including a portion configured with a U-shaped cross section by at least one first sheet portion of which a sheet surface faces in the up-down direction, and a plurality of second sheet portions which extend from the first sheet portion in the up-down direction and of which sheet surfaces face sideways, the device comprising:
a robot hand provided in a robot;
at least one suction unit provided on the robot hand, and capable of suctioning and lifting the first sheet portion of the workpiece located at an upper end of the workpiece stack; and
at least one deformation device provided on the robot hand, and capable of elastically deforming at least one of the plurality of second sheet portions of the workpiece in a sheet surface direction of the second sheet portion, the workpiece being located at the upper end, with a contact portion with the overlapping workpiece immediately below as a fulcrum, and linking the elastic deformation to the confronting second sheet portion via the suction unit.

2. The workpiece take-out device according to claim 1, further comprising:
a control unit that controls the robot hand, the suction unit, and the deformation device,
wherein the control unit is configured at least to control the deformation device to elastically deform the second sheet portion of the workpiece located at the upper end of the workpiece stack when the suction unit suctions the first sheet portion of the workpiece located at the upper end, and to control the deformation device to separate away from the second sheet portion when the suction unit lifts the first sheet portion.

3. The workpiece take-out device according to claim 2,
wherein when the uppermost workpiece that is lifted from the workpiece stack by the suction unit is referred to as an upper workpiece, and the overlapping workpiece immediately below the upper workpiece is referred to as a lower workpiece, the control unit is configured to control the deformation device to continue the elastic deformation operation of the second sheet portion until it is determined that the lifting of the upper workpiece to a separation position with respect to the lower workpiece is completed.

4. The workpiece take-out device according to claim 2, further comprising:
a 3D vision sensor provided on the robot hand to be able to detect a position and an angle of the workpiece located at the upper end of the workpiece stack,
wherein the control unit is configured to correct a posture of the robot hand based on the position and the angle of the workpiece located at the upper end, which are detected by the 3D vision sensor.

5. The workpiece take-out device according to claim 1,
wherein the workpiece is a vehicle body panel constituting a part of a vehicle body, and includes at least one protruding portion that protrudes upward when the workpiece is stacked as the workpiece stack,
the protruding portion is a portion configured with a U-shaped cross section by the first sheet portion and the plurality of second sheet portions,
each of end portions of the second sheet portions includes a folded flange,
the suction unit is configured to be able to suction and lift the first sheet portion composed of the protruding portion of the workpiece located at the upper end of the workpiece stack, and
the deformation device is positioned to be able to elastically deform one of the plurality of second sheet portions of the workpiece in the sheet surface direction of the second sheet portion, the workpiece being located at the upper end.

6. The workpiece take-out device according to claim 1,
wherein the workpiece includes at least four second sheet portions, and
the deformation devices are arranged in two different directions to be able to elastically deform two second sheet portions of the workpiece located at the upper end of the workpiece stack, the two second sheet portions being adjacent to each other via a ridge, in respective sheet surface directions.

7. The workpiece take-out device according to claim 1,
wherein the deformation device includes a vibrator that applies vibration to the second sheet portion in the sheet surface direction, at least in a state where the suction unit lifts the first sheet portion of the workpiece located at the upper end of the workpiece stack.

8. The workpiece take-out device according to claim 1,
wherein vertices of a triangle are assumed when the workpiece is viewed from above, and
the suction units are disposed at positions corresponding to the vertices of the triangle on the workpiece located at the upper end of the workpiece stack.

9. The workpiece take-out device according to claim 1,
wherein when the workpiece located at the upper end of the workpiece stack is referred to as a highest-positioned workpiece, the overlapping workpiece immediately below the highest-positioned workpiece is referred to as a lower-positioned workpiece, among the plurality of second sheet portions of the highest-positioned workpiece, the second sheet portion that is elastically deformed in the sheet surface direction by the deformation device is referred to as a specific second sheet portion, and the other second sheet portion excluding the specific second sheet portion is referred to as a remaining second sheet portion, a deformation amount by which the specific second sheet portion is elastically deformed by the deformation device is set to a size that can separate a state of fitting of the remaining second sheet portion to the lower-positioned workpiece.

10. The workpiece take-out device according to claim 1,
wherein the deformation device includes a spring that applies a biasing force to the sheet surface of the second sheet portion of the workpiece located at the upper end of the workpiece stack, the biasing force being capable of bringing an entirety of the workpiece, which is located at the upper end, into an elastic deformation state, together with the second sheet portion of the workpiece, and an actuator that releases the application of the biasing force of the spring.

11. The workpiece take-out device according to claim 1,
wherein the deformation device includes an actuator that applies a pushing force to the sheet surface of the second sheet portion of the workpiece located at the upper end of the workpiece stack, the pushing force being capable of bringing an entirety of the workpiece, which is located at the upper end, into an elastic deformation state, together with the second sheet portion of the workpiece, and that can also release the application of the pushing force.

12. The workpiece take-out device according to claim 1,
wherein the deformation device includes at least a spring mechanism that elastically deforms the second sheet portion of the workpiece located at the upper end of the workpiece stack in a state where the suction unit suctions the first sheet portion of the workpiece located at the upper end and pushes down the first sheet portion, and an actuator that separates the spring mechanism away from the second sheet portion in a state where the suction unit lifts the first sheet portion.
